(19) United States
(12) Patent Application Publication
(10) Pub. No.: US 2023/0199782 A1
(43) Pub. Date: Jun. 22, 2023

(54) SECONDARY CELL DORMANCY INDICATION FOR SCHEDULING MULTIPLE COMPONENT CARRIERS

(71) Applicant: QUALCOMM INCORPORATED, San Diego, CA (US)

(72) Inventors: Kazuki TAKEDA, Minato-ku (JP); Wanshi CHEN, San Diego, CA (US); Peter GAAL, San Diego, CA (US); Tao LUO, San Diego, CA (US); Xiaoxia ZHANG, San Diego, CA (US); Alberto RICO ALVARINO, San Diego, CA (US); Mostafa KHOSHNEVISAN, San Diego, CA (US); Yiqing CAO, Beijing (CN)

(21) Appl. No.: 17/996,065

(22) PCT Filed: May 15, 2020
(86) PCT No.: PCT/CN2020/090614

§ 371 Date: Oct. 12, 2022

(51) Int. Cl. H04W 72/23; H04W 72/1263; H04L 5/00; H04L 1/1812

(52) U.S. Cl. CPC H04W 72/23; H04W 72/1263; H04L 5/001; H04L 1/1812

(57) ABSTRACT

Methods, systems, and devices for wireless communications are described. A user equipment (UE) may receive, from a base station, a downlink control information (DCI) message associated with scheduling transmissions for the UE on a plurality of component carriers. The UE may determine, for at least a first component carrier of the plurality of component carriers, that a frequency resource allocation field of the DCI message comprises an indication of a value that is invalid for frequency resource allocation on the first component carrier. The UE may determine, based at least in part on the invalid indication and using a subset of fields of the DCI message corresponding to the first component carrier, that one or more component carriers of the plurality of component carriers are dormant.

### CROSS REFERENCE

The present Application is a 371 national stage filing of International PCT Application No. PCT/CN2020/090614 by TAKEDA et al. entitled “SECONDARY CELL DORMANCY INDICATION FOR SCHEDULING MULTIPLE COMPONENT CARRIERS,” filed May 15, 2020; which is assigned to the assignee hereof, and which is expressly incorporated by reference in its entirety herein.

### FIELD OF TECHNOLOGY

The following relates generally to wireless communications and more specifically to secondary cell dormancy indication for scheduling multiple component carriers.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support secondary cell dormancy indication for scheduling multiple component carriers. Generally, the described techniques provide various mechanisms for physical downlink control channel (PDCCH) enhancements for cross-carrier scheduling. Aspects of the described techniques utilize a downlink control information (DCI) message indicating secondary cell (SCell) dormancy information, e.g., dormancy information for component carrier(s) (CC)(s) associated with a SCell. For example, a base station may determine or otherwise identify that CC(s) of a plurality of CCs are dormant for a UE. Accordingly, the base station may configure a frequency resource allocation field (e.g., a frequency domain resource allocation (FDRA) field) of a DCI message to indicate a value that is invalid for frequency resource allocation on at least a first CC of the plurality of CCs, e.g., a value or sequence that is not otherwise available for scheduling frequency resources for the first CC. The base station may also configure a subset of fields of the DCI message to convey or otherwise indicate information associated with the dormant CC(s) (e.g., information identifying the dormant CC(s) of the plurality of CCs). The base station may transmit the DCI message to the UE, which determines that the frequency resource allocation field indicates a value invalid for frequency resource allocation. Based on the invalid indication, the UE may determine or otherwise identify the dormant CC(s) of the plurality of CCs. For example, the UE may determine that the DCI message indicates dormant CCs based on the invalid indication, and identify which CC(s) are dormant based on the information included in the subset of fields (e.g., such as a modulation and coding scheme (MCS) field, a new data indicator (NDI) field, a redundancy version (RV) field, a hybrid automatic repeat/request (HARD) field, an antenna port (AP) field, and the like).

Additionally or alternatively, aspects of the described techniques support utilizing the frequency resource allocation field (and the subset of other fields, in some examples) of a DCI message to indicate the activation/release of semi-persistent resources (e.g., semi-persistent scheduling (SPS) resources and/or configured grant (CG) resources) configured for UE. For example, the base station may transmit or otherwise convey an indication of a configuration for the semi-persistent resources for the UE using a plurality of CCs. The base station may determine the activation status for the semi-persistent resources and, therefore, configure the frequency resource allocation field (e.g., the FDRA field) for at least a first CC of the plurality of CCs to indicate a value that is invalid for frequency resource allocation on the first CC. Accordingly, the base station may transmit or otherwise convey the DCI message to the UE indicating the value that is invalid for frequency resource allocation. The UE may receive the DCI message and determine that it indicates the value that is invalid for frequency resource allocation. Accordingly, the UE may determine the activation status for the semi-persistent resources based on the invalid indication. For example, the NDI field in the DCI message may be set to “0” and the FDRA field may indicate the invalid value, which may signal to the UE that this DCI is for SPS/CG activation/release. The HARQ process number field, RV field, and the like, in the DCI message may include information associated with the semi-persistent resources being activated/released, e.g., identifying information.

A method of wireless communications at a UE is described. The method may include receiving, from a base station, a DCI message associated with scheduling transmissions for the UE on a set of CCs, determining, for at least a first CC of the set of CCs, that a frequency resource allocation field of the DCI message includes an indication of a value that is invalid for frequency resource allocation on the first CC, and determining, based on the invalid indication and using a subset of fields of the DCI message corresponding to the first CC, that one or more CCs of the set of CCs are dormant.

An apparatus for wireless communications at a UE is described. The apparatus may include a processor, memory coupled with the processor, and instructions stored in the memory. The instructions may be executable by the processor to cause the apparatus to receive, from a base station, a DCI message associated with scheduling transmissions for the UE on a set of CCs, determine, for at least a first CC of the set of CCs, that a frequency resource allocation field of the DCI message includes an indication of a value that is invalid for frequency resource allocation on the first CC, and determine, based on the invalid indication and using a subset of fields of the DCI message corresponding to the first CC, that one or more CCs of the set of CCs are dormant.

Another apparatus for wireless communications at a UE is described. The apparatus may include means for receiving, from a base station, a DCI message associated with scheduling transmissions for the UE on a set of CCs, determining, for at least a first CC of the set of CCs, that a frequency resource allocation field of the DCI message includes an indication of a value that is invalid for frequency resource allocation on the first CC, and determining, based on the invalid indication and using a subset of fields of the DCI message corresponding to the first CC, that one or more CCs of the set of CCs are dormant.

A non-transitory computer-readable medium storing code for wireless communications at a UE is described. The code may include instructions executable by a processor to receive, from a base station, a DCI message associated with scheduling transmissions for the UE on a set of CCs, determine, for at least a first CC of the set of CCs, that a frequency resource allocation field of the DCI message includes an indication of a value that is invalid for frequency resource allocation on the first CC, and determine, based on the invalid indication and using a subset of fields of the DCI message corresponding to the first CC, that one or more CCs of the set of CCs are dormant.

Some examples of the method, apparatuses, and non-transitory computer-readable medium described herein may further include operations, features, means, or instructions for determining that a bit in a resource allocation type field in the DCI message may be set to a first value, and determining that each bit in a bitmap indicated in the frequency resource allocation field associated with the first CC in the DCI message may be set to the first value, where the value being invalid for frequency resource allocation on the first CC may be based on each bit in the bitmap being set to the first value.

Some examples of the method, apparatuses, and non-transitory computer-readable medium described herein may further include operations, features, means, or instructions for identifying, based on the subset of fields of the DCI message, the dormant one or more CCs of the set of CCs.

In some examples of the method, apparatuses, and non-transitory computer-readable medium described herein, identifying the dormant one or more CCs may include operations, features, means, or instructions for mapping each bit of a bitmap indicated in the subset of fields to a CC of the set of CCs, and determining, based on a value of each bit and the mapping, that the CC may be active or dormant.

Some examples of the method, apparatuses, and non-transitory computer-readable medium described herein may further include operations, features, means, or instructions for determining, for at least a second CC of the set of CCs, that the frequency resource allocation field of the DCI message associated with the second CC includes an indication of a value that may be invalid for frequency resource allocation on the second CC.

Some examples of the method, apparatuses, and non-transitory computer-readable medium described herein may further include operations, features, means, or instructions for determining that a bit in a resource allocation type field associated with the second CC in the DCI message may be set to a first value, and determining that each bit in a bitmap in the frequency resource allocation field associated with the second CC in the DCI message may be set to the first value, where the value being invalid for frequency resource allocation on the second CC may be based on each bit in the bitmap being set to the first value.

Some examples of the method, apparatuses, and non-transitory computer-readable medium described herein may further include operations, features, means, or instructions for identifying, based on the subset of fields associated with the first CC in the DCI message, a second subset of fields associated with the second CC in the DCI message, and a common subset of fields in the DCI message, the dormant one or more CCs of the set of CCs.

In some examples of the method, apparatuses, and non-transitory computer-readable medium described herein, identifying the dormant one or more CCs may include operations, features, means, or instructions for mapping each bit of a bitmap indicated in the subset of fields, the second subset of fields, and the common subset of fields, to a CC of the set of CCs, and determining, based on a value of each bit and the mapping, that the CC may be active or dormant.

In some examples of the method, apparatuses, and non-transitory computer-readable medium described herein, the frequency resource allocation field may include operations, features, means, or instructions for determining, based on the joint frequency resource allocation field, that no resources may be allocated to the first CC, where the value being invalid for frequency resource allocation on the first CC may be based on no resources allocated to the first CC.

Some examples of the method, apparatuses, and non-transitory computer-readable medium described herein may further include operations, features, means, or instructions for identifying, based on the subset of fields of the DCI message, the dormant one or more CCs of the set of CCs.

In some examples of the method, apparatuses, and non-transitory computer-readable medium described herein, identifying the dormant one or more CCs may include operations, features, means, or instructions for mapping each bit of a bitmap indicated in the subset of fields to a CC of the set of CCs, and determining, based on a value of each bit and the mapping, that the CC may be active or dormant.

Some examples of the method, apparatuses, and non-transitory computer-readable medium described herein may further include operations, features, means, or instructions for determining, for at least the second CC of the set of CCs, that no resources may be allocated to the second CC, where the value being invalid for frequency resource allocation on the second CC may be based on no resources allocated to the second CC.

Some examples of the method, apparatuses, and non-transitory computer-readable medium described herein may further include operations, features, means, or instructions for identifying, based on the subset of fields associated with the first CC in the DCI message, a second subset of fields associated with the second CC in the DCI message, and a common subset of fields in the DCI message, the dormant one or more CCs of the set of CCs.

In some examples of the method, apparatuses, and non-transitory computer-readable medium described herein, identifying the dormant one or more CCs may include operations, features, means, or instructions for mapping each bit of a bitmap indicated in the subset of fields, the second subset of fields, and the common subset of fields, to a CC of the set of CCs, and determining, based on a value of each bit and the mapping, that the CC may be active or dormant.

In some examples of the method, apparatuses, and non-transitory computer-readable medium described herein, the subset of fields of the DCI message include one or more of a MCS, a NDI field, or a RV field.

A method of wireless communication at a UE is described. The method may include receiving a configuration of semi-persistent resources for the UE using a set of CCs, receiving, from a base station, a DCI message associated with scheduling transmissions for the UE on the set of CCs, determining, for at least a first CC of the set of CCs, that a frequency resource allocation field of the DCI message includes an indication of a value that is invalid for frequency resource allocation on the first CC, and determining, based on the invalid indication, an activation status for the semi-persistent resources.

An apparatus for wireless communication at a UE is described. The apparatus may include a processor, memory coupled with the processor, and instructions stored in the memory. The instructions may be executable by the processor to cause the apparatus to receive a configuration of semi-persistent resources for the UE using a set of CCs, receive, from a base station, a DCI message associated with scheduling transmissions for the UE on the set of CCs, determine, for at least a first CC of the set of CCs, that a frequency resource allocation field of the DCI message includes an indication of a value that is invalid for frequency resource allocation on the first CC, and determine, based on the invalid indication, an activation status for the semi-persistent resources.

Another apparatus for wireless communication at a UE is described. The apparatus may include means for receiving a configuration of semi-persistent resources for the UE using a set of CCs, receiving, from a base station, a DCI message associated with scheduling transmissions for the UE on the set of CCs, determining, for at least a first CC of the set of CCs, that a frequency resource allocation field of the DCI message includes an indication of a value that is invalid for frequency resource allocation on the first CC, and determining, based on the invalid indication, an activation status for the semi-persistent resources.

A non-transitory computer-readable medium storing code for wireless communication at a UE is described. The code may include instructions executable by a processor to receive a configuration of semi-persistent resources for the UE using a set of CCs, receive, from a base station, a DCI message associated with scheduling transmissions for the UE on the set of CCs, determine, for at least a first CC of the set of CCs, that a frequency resource allocation field of the DCI message includes an indication of a value that is invalid for frequency resource allocation on the first CC, and determine, based on the invalid indication, an activation status for the semi-persistent resources.

Some examples of the method, apparatuses, and non-transitory computer-readable medium described herein may further include operations, features, means, or instructions for determining that the DCI message includes a separate hybrid automatic repeat/request (HARD) process number field for each CC in the set of CCs.

Some examples of the method, apparatuses, and non-transitory computer-readable medium described herein may further include operations, features, means, or instructions for determining the activation status for a semi-persistent resource associated with the first CC based on each bit in the HARQ process number field and a RV field being set to a first value.

Some examples of the method, apparatuses, and non-transitory computer-readable medium described herein may further include operations, features, means, or instructions for determining the activation status for a set of semi-persistent resources associated with the first CC based on each bit in a RV field being set to a first value, and identifying the set of semi-persistent resources based on the HARQ process number field.

Some examples of the method, apparatuses, and non-transitory computer-readable medium described herein may further include operations, features, means, or instructions for determining that the DCI message includes a joint HARQ process number field for each CC in the set of CCs.

Some examples of the method, apparatuses, and non-transitory computer-readable medium described herein may further include operations, features, means, or instructions for determining the activation status for a semi-persistent resource associated with the first CC based on each bit in the HARQ process number field and a RV field being set to a first value.

Some examples of the method, apparatuses, and non-transitory computer-readable medium described herein may further include operations, features, means, or instructions for determining the activation status for a set of semi-persistent resources associated with the first CC based on each bit in a RV field being set to a first value, and identifying the set of semi-persistent resources associated with the first CC and a second CC based on the HARQ process number field.

In some examples of the method, apparatuses, and non-transitory computer-readable medium described herein, the DCI message includes at least one of a separate frequency resource allocation field for each CC of the set of CCs or a joint frequency resource allocation field for the set of CCs.

A method of wireless communications at a base station is described. The method may include determining, for a UE, that one or more CCs of a set of CCs that are dormant, configuring a frequency resource allocation field of a DCI message to indicate a value that is invalid for frequency resource allocation on at least a first CC of the set of CCs and a subset of fields of the DCI message indicating information associated with the dormant one or more CCs, and transmitting, to the UE, the DCI message associated with scheduling transmissions for the UE on the set of CCs.

An apparatus for wireless communications at a base station is described. The apparatus may include a processor, memory coupled with the processor, and instructions stored in the memory. The instructions may be executable by the processor to cause the apparatus to determine, for a UE, that one or more CCs of a set of CCs that are dormant, configure a frequency resource allocation field of a DCI message to indicate a value that is invalid for frequency resource allocation on at least a first CC of the set of CCs and a subset of fields of the DCI message indicating information associated with the dormant one or more CCs, and transmit, to the UE, the DCI message associated with scheduling transmissions for the UE on the set of CCs.

Another apparatus for wireless communications at a base station is described. The apparatus may include means for determining, for a UE, that one or more CCs of a set of CCs that are dormant, configuring a frequency resource allocation field of a DCI message to indicate a value that is invalid for frequency resource allocation on at least a first CC of the set of CCs and a subset of fields of the DCI message indicating information associated with the dormant one or more CCs, and transmitting, to the UE, the DCI message associated with scheduling transmissions for the UE on the set of CCs.

A non-transitory computer-readable medium storing code for wireless communications at a base station is described. The code may include instructions executable by a processor to determine, for a UE, that one or more CCs of a set of CCs that are dormant, configure a frequency resource allocation field of a DCI message to indicate a value that is invalid for frequency resource allocation on at least a first CC of the set of CCs and a subset of fields of the DCI message indicating information associated with the dormant one or more CCs, and transmit, to the UE, the DCI message associated with scheduling transmissions for the UE on the set of CCs.

Some examples of the method, apparatuses, and non-transitory computer-readable medium described herein may further include operations, features, means, or instructions for setting a bit in a resource allocation type field in the DCI message to a first value, and setting each bit in a bitmap indicated in the frequency resource allocation field associated with the first CC in the DCI message to the first value, where the value being invalid for frequency resource allocation on the first CC may be based on each bit in the bitmap being set to the first value.

Some examples of the method, apparatuses, and non-transitory computer-readable medium described herein may further include operations, features, means, or instructions for configuring the subset of fields of the DCI message to indicate information identifying the dormant one or more CCs of the set of CCs.

Some examples of the method, apparatuses, and non-transitory computer-readable medium described herein may further include operations, features, means, or instructions for mapping each bit of a bitmap indicated in the subset of fields to a CC of the set of CCs, where a value of each bit and the mapping indicate that the CC may be active or dormant.

Some examples of the method, apparatuses, and non-transitory computer-readable medium described herein may further include operations, features, means, or instructions for configuring the frequency resource allocation field of the DCI message associated with a second CC to indicate the value that may be invalid for frequency resource allocation on the second CC.

Some examples of the method, apparatuses, and non-transitory computer-readable medium described herein may further include operations, features, means, or instructions for setting a bit in a resource allocation type field associated with the second CC in the DCI message to a first value, and setting each bit in a bitmap in the frequency resource allocation field associated with the second CC in the DCI message to the first value, where the value being invalid for frequency resource allocation on the second CC may be based on each bit in the bitmap being set to the first value.

Some examples of the method, apparatuses, and non-transitory computer-readable medium described herein may further include operations, features, means, or instructions for configuring the subset of fields associated with the first CC in the DCI message, a second subset of fields associated with the second CC in the DCI message, and a common subset of fields in the DCI message, to indicate information associated with the dormant one or more CCs of the set of CCs.

Some examples of the method, apparatuses, and non-transitory computer-readable medium described herein may further include operations, features, means, or instructions for mapping each bit of a bitmap indicated in the subset of fields, the second subset of fields, and the common subset of fields, to a CC of the set of CCs, where a value of each bit and the mapping indicates that the CC may be active or dormant.

In some examples of the method, apparatuses, and non-transitory computer-readable medium described herein, the frequency resource allocation field may include operations, features, means, or instructions for configuring the joint frequency resource allocation field to indicate that no resources may be allocated to the first CC, where the value being invalid for frequency resource allocation on the first CC may be based on no resources allocated to the first CC.

Some examples of the method, apparatuses, and non-transitory computer-readable medium described herein may further include operations, features, means, or instructions for configuring the subset of fields of the DCI message to indicate information identifying the dormant one or more CCs of the set of CCs.

Some examples of the method, apparatuses, and non-transitory computer-readable medium described herein may further include operations, features, means, or instructions for mapping each bit of a bitmap indicated in the subset of fields to a CC of the set of CCs, and setting a value of each bit in the bitmap to indicate that the CC may be active or dormant.

Some examples of the method, apparatuses, and non-transitory computer-readable medium described herein may further include operations, features, means, or instructions for configuring the frequency resource allocation field of the DCI message to indicate that no resources may be allocated to the second CC, where the value being invalid for frequency resource allocation on the second CC may be based on no resources allocated to the second CC.

Some examples of the method, apparatuses, and non-transitory computer-readable medium described herein may further include operations, features, means, or instructions for configuring the subset of fields associated with the first CC in the DCI message, a second subset of fields associated with the second CC in the DCI message, and a common subset of fields in the DCI message, to indicate information identifying the dormant one or more CCs of the set of CCs.

Some examples of the method, apparatuses, and non-transitory computer-readable medium described herein may further include operations, features, means, or instructions for mapping each bit of a bitmap indicated in the subset of fields, the second subset of fields, and the common subset of fields, to a CC of the set of CCs, and setting a value of each bit in the bitmap to indicate that the CC may be active or dormant.

In some examples of the method, apparatuses, and non-transitory computer-readable medium described herein, the subset of fields of the DCI message include one or more of a MCS, a NDI field, or a RV field.

A method of wireless communication at a base station is described. The method may include transmitting, to a UE, a DCI message associated with scheduling transmissions for the UE on a set of CCs, determining an activation status for the semi-persistent resources, configuring, for at least a first CC of the set of CCs and the activation status, a frequency resource allocation field of a DCI message to indicate a value that is invalid for frequency resource allocation on the first CC, and transmitting the DCI message to the UE conveying the invalid indication.

An apparatus for wireless communication at a base station is described. The apparatus may include a processor, memory coupled with the processor, and instructions stored in the memory. The instructions may be executable by the processor to cause the apparatus to transmit, to a UE, a DCI message associated with scheduling transmissions for the UE on a set of CCs, determine an activation status for the semi-persistent resources, configure, for at least a first CC of the set of CCs and the activation status, a frequency resource allocation field of a DCI message to indicate a value that is invalid for frequency resource allocation on the first CC, and transmit the DCI message to the UE conveying the invalid indication.

Another apparatus for wireless communication at a base station is described. The apparatus may include means for transmitting, to a UE, a DCI message associated with scheduling transmissions for the UE on a set of CCs, determining an activation status for the semi-persistent resources, configuring, for at least a first CC of the set of CCs and the activation status, a frequency resource allocation field of a DCI message to indicate a value that is invalid for frequency resource allocation on the first CC, and transmitting the DCI message to the UE conveying the invalid indication.

A non-transitory computer-readable medium storing code for wireless communication at a base station is described. The code may include instructions executable by a processor to transmit, to a UE, a DCI message associated with scheduling transmissions for the UE on a set of CCs, determine an activation status for the semi-persistent resources, configure, for at least a first CC of the set of CCs and the activation status, a frequency resource allocation field of a DCI message to indicate a value that is invalid for frequency resource allocation on the first CC, and transmit the DCI message to the UE conveying the invalid indication.

Some examples of the method, apparatuses, and non-transitory computer-readable medium described herein may further include operations, features, means, or instructions for configuring a separate HARQ process number field in the DCI message for each CC in the set of CCs.

Some examples of the method, apparatuses, and non-transitory computer-readable medium described herein may further include operations, features, means, or instructions for configuring each bit in the HARQ process number field and a redundancy field of the DCI message to indicate the activation status for a semi-persistent resource associated with the first CC.

Some examples of the method, apparatuses, and non-transitory computer-readable medium described herein may further include operations, features, means, or instructions for setting each bit in a RV field to a first value based on the activation status for a set of semi-persistent resources associated with the first CC, where an identity of the set of semi-persistent resources may be based on the HARQ process number field.

Some examples of the method, apparatuses, and non-transitory computer-readable medium described herein may further include operations, features, means, or instructions for configuring a joint HARQ process number field in the DCI message for each CC in the set of CCs.

Some examples of the method, apparatuses, and non-transitory computer-readable medium described herein may further include operations, features, means, or instructions for configuring the joint HARQ process number field and a redundancy field in the DCI message based on the activation status for a semi-persistent resource associated with the first CC.

Some examples of the method, apparatuses, and non-transitory computer-readable medium described herein may further include operations, features, means, or instructions for setting each bit in a RV field to a first value based on the activation status for a set of semi-persistent resources associated with the first CC, where the semi-persistent resources associated with the first CC may be identified based on the joint HARQ process number field.

In some examples of the method, apparatuses, and non-transitory computer-readable medium described herein, the DCI message includes at least one of a separate frequency resource allocation field for each CC of the set of CCs or a joint frequency resource allocation field for the set of CCs.

### BRIEF DESCRIPTION OF THE DRAWINGS

FIG. 1 illustrates an example of a system for wireless communications that supports secondary cell dormancy indication for scheduling multiple component carriers in accordance with aspects of the present disclosure.

FIG. 2 illustrates an example of a CC configuration that supports secondary cell dormancy indication for scheduling multiple component carriers in accordance with aspects of the present disclosure.

FIG. 3 illustrates an example of a DCI configuration that supports secondary cell dormancy indication for scheduling multiple component carriers in accordance with aspects of the present disclosure.

FIG. 4 illustrates an example of a DCI configuration that supports secondary cell dormancy indication for scheduling multiple component carriers in accordance with aspects of the present disclosure.

FIG. 5 illustrates an example of a process that supports secondary cell dormancy indication for scheduling multiple component carriers in accordance with aspects of the present disclosure.

FIG. 6 illustrates an example of a process that supports secondary cell dormancy indication for scheduling multiple component carriers in accordance with aspects of the present disclosure.

FIGS. 7 and 8 show block diagrams of devices that support secondary cell dormancy indication for scheduling multiple component carriers in accordance with aspects of the present disclosure.

FIG. 9 shows a block diagram of a communications manager that supports secondary cell dormancy indication for scheduling multiple component carriers in accordance with aspects of the present disclosure.

FIG. 10 shows a diagram of a system including a device that supports secondary cell dormancy indication for scheduling multiple component carriers in accordance with aspects of the present disclosure.

FIGS. 11 and 12 show block diagrams of devices that support secondary cell dormancy indication for scheduling multiple component carriers in accordance with aspects of the present disclosure.

FIG. 13 shows a block diagram of a communications manager that supports secondary cell dormancy indication for scheduling multiple component carriers in accordance with aspects of the present disclosure.

FIG. 14 shows a diagram of a system including a device that supports secondary cell dormancy indication for scheduling multiple component carriers in accordance with aspects of the present disclosure.

FIGS. 15 through 19 show flowcharts illustrating methods that support secondary cell dormancy indication for scheduling multiple component carriers in accordance with aspects of the present disclosure.

### DETAILED DESCRIPTION

Wireless communication systems may use a grant, such as a downlink control information (DCI) grant) to schedule transmissions for a user equipment (UE) on a plurality of component carriers (CCs). For example, the wireless communications system may include a primary cell (PCell) that uses a dynamic spectrum sharing (DSS) carrier using 15 kHz sub-carrier spacing (SCS) while a secondary cell (SCell) uses a non-DSS carrier using 30 kHz or 15 kHz SCS (although the described techniques are not limited to these SCS combinations). The DCI grant may be transmitted from a carrier and schedule transmissions for the UE on the DSS carrier of the PCell and schedule transmissions for the UE on the non-DSS carrier of the SCell. However, improvements at the scheduling entity may be realized by transmitting the grant on s carrier that schedules transmissions for the UE on the DSS carrier associated with the PCell as well as the non-DSS carrier associated with the SCell. For example, this may be beneficial due to a single DCI being used for scheduling data on multiple carriers, rather than using multiple DCIs.

Aspects of the disclosure are initially described in the context of wireless communications systems. Generally, the described techniques provide various mechanisms for physical downlink control channel (PDCCH) enhancements for multi-CC scheduling. Aspects of the described techniques utilize a DCI message (e.g., a DCI message) indicating SCell dormancy information, e.g., dormancy information for CC(s) associated with a SCell. For example, a base station may determine or otherwise identify that CC(s) of a plurality of CCs are dormant for a UE. Accordingly, the base station may configure a frequency resource allocation field (e.g., a frequency domain resource allocation (FDRA) field) of a DCI message to indicate a value that is invalid for frequency resource allocation on at least a first CC of the plurality of CCs, e.g., a value or sequence that is not otherwise available for scheduling frequency resources for the first CC. The base station may also configure a subset of fields of the DCI message to convey or otherwise indicate information associated with the dormant CC(s) (e.g., information identifying the dormant CC(s) of the plurality of CCs). The base station may transmit the DCI message to the UE, which determines that the frequency resource allocation field indicates a value invalid for frequency resource allocation. Based on the invalid indication, the UE may determine or otherwise identify the dormant CC(s) of the plurality of CCs. For example, the UE may determine that the DCI message indicates dormant CCs based on the invalid indication, and identify which CC(s) are dormant based on the information included in the subset of fields (e.g., such as a modulation and coding scheme (MCS) field, a new data indicator (NDI) field, a redundancy version (RV) field, a hybrid automatic repeat/request (HARD) field, an antenna port (AP) field, and the like).

Additionally or alternatively, aspects of the described techniques support utilizing the frequency resource allocation field (and the subset of other fields, in some examples) of a DCI message to indicate the activation/release of semi-persistent resources (e.g., semi-persistent scheduling (SPS) resources and/or configured grant (CG) resources) configured for UE. For example, the base station may transmit or otherwise convey an indication of a configuration for the semi-persistent resources for the UE using a plurality of CCs. The base station may determine the activation status for the semi-persistent resources and, therefore, configure the frequency resource allocation field (e.g., the FDRA field) for at least a first CC of the plurality of CCs to indicate a value that is invalid for frequency resource allocation on the first CC. Accordingly, the base station may transmit or otherwise convey the DCI message to the UE indicating the value that is invalid for frequency resource allocation. The UE may receive the DCI message and determine that it indicates the value that is invalid for frequency resource allocation. Accordingly, the UE may determine the activation status for the semi-persistent resources based on the invalid indication. For example, the NDI field in the DCI message may be set to “0” and the FDRA field may indicate the invalid value, which may signal to the UE that this DCI is for SPS/CG activation/release. The HARQ process number field, RV field, and the like, in the DCI message may include information associated with the semi-persistent resources being activated/released, e.g., identifying information.

Aspects of the disclosure are further illustrated by and described with reference to apparatus diagrams, system diagrams, and flowcharts that relate to secondary cell dormancy indication for scheduling multiple component carriers.

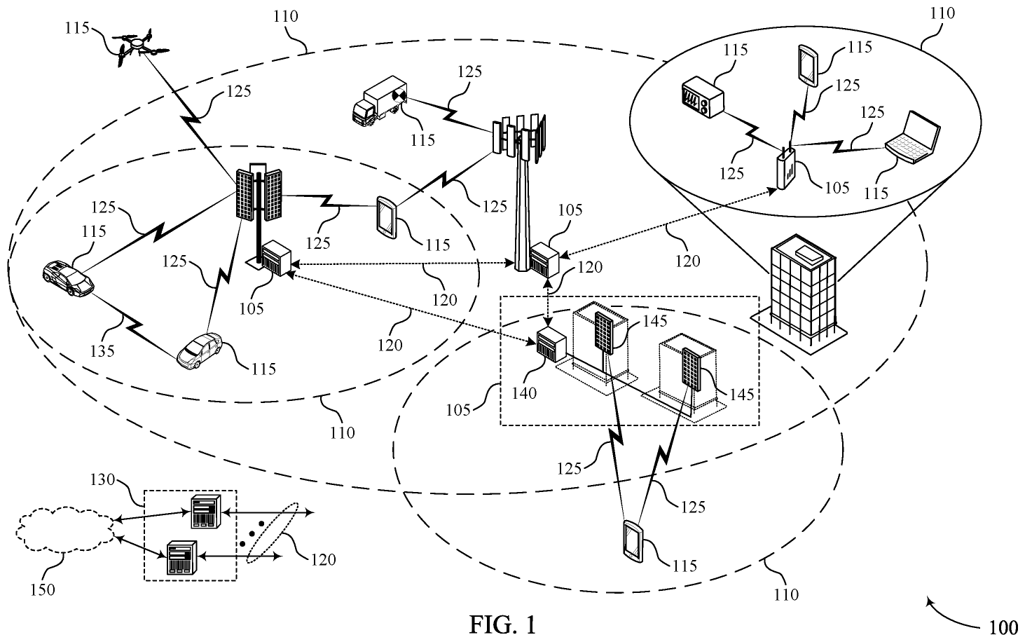

FIG. 1 illustrates an example of a wireless communications system 100 that supports secondary cell dormancy indication for scheduling multiple component carriers in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an 51, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., NN_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may receive, from a base station 105, a DCI message associated with scheduling transmissions for the UE 115 on a plurality of component carriers. The UE 115 may determine, for at least a first component carrier of the plurality of component carriers, that a frequency resource allocation field of the downlink control information message comprises an indication of a value that is invalid for frequency resource allocation on the first component carrier. The UE 115 may determine, based at least in part on the invalid indication and using a subset of fields of the DCI message corresponding to the first component carrier, that one or more component carriers of the plurality of component carriers are dormant.

A UE 115 may receive a configuration of semi-persistent resources for the UE using a plurality of component carriers. The UE 115 may receive, from a base station 105, a downlink control information message associated with scheduling transmissions for the UE 115 on the plurality of component carriers. The UE 115 may determine, for at least a first component carrier of the plurality of component carriers, that a frequency resource allocation field of the DCI message comprises an indication of a value that is invalid for frequency resource allocation on the first component carrier. The UE 115 may determine, based at least in part on the invalid indication, an activation status for the semi-persistent resources.

A base station 105 may determine, for a UE 115, that one or more component carriers of a plurality of component carriers that are dormant. The base station 105 may configure a frequency resource allocation field of a DCI message to indicate a value that is invalid for frequency resource allocation on at least a first component carrier of the plurality of component carriers and a subset of fields of the DCI message indicating information associated with the dormant one or more component carriers. The base station 105 may transmit, to the UE 115, the DCI message associated with scheduling transmissions for the UE 115 on the plurality of component carriers.

A base station 105 may transmit, to a UE 115, a configuration of semi-persistent resources for the UE 115 using a plurality of component carriers. The base station 105 may determine an activation status for the semi-persistent resources. The base station 105 may configure, for at least a first component carrier of the plurality of component carriers and the activation status, a frequency resource allocation field of a DCI message to indicate a value that is invalid for frequency resource allocation on the first component carrier. The base station 105 may transmit the DCI message to the UE 115 conveying the invalid indication.

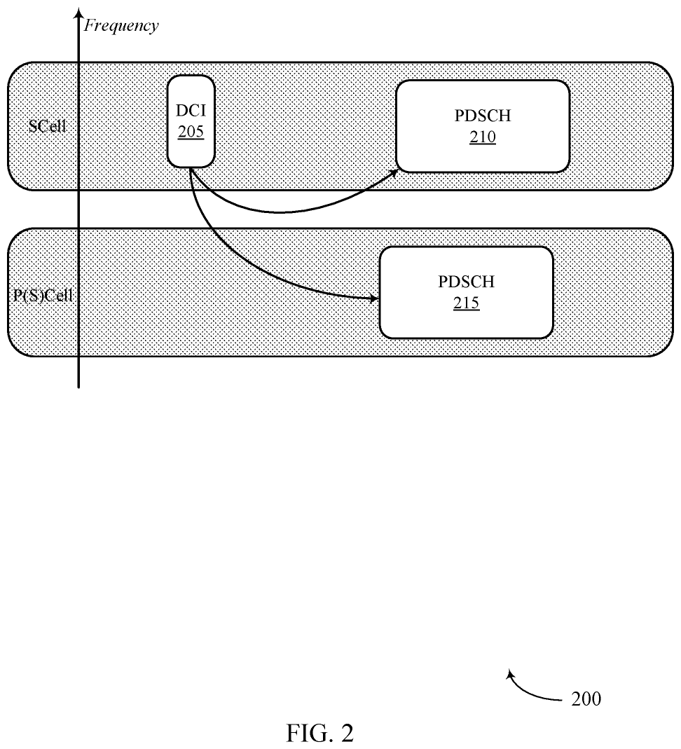

FIG. 2 illustrates an example of a CC configuration 200 that supports secondary cell dormancy indication for scheduling multiple component carriers in accordance with aspects of the present disclosure. In some examples, CC configuration 200 may implement aspects of wireless communication system 100. Aspects of CC configuration 200 may be implemented by a base station (e.g., a PCell and/or SCell) and a UE, which may be examples of the corresponding devices described herein.

Wireless communication systems may use a grant, such as a DCI grant, to schedule transmissions for a UE on a plurality of CCs. For example, the wireless communications system may include a PCell that uses a DSS carrier using 15 kHz SCS while a SCell uses a non-DSS carrier using 30 kHz or 15 kHz SCS (although the described techniques are not limited to these SCS combinations). In some examples, the DCI grant may be transmitted from a carrier associated with the PCell and schedule transmissions for the UE on the DSS carrier of the PCell and schedule transmissions for the UE on the non-DSS carrier of the SCell. However, improvements at the scheduling entity may be realized by transmitting the grant on the non-DSS carrier of the SCell that schedules transmissions for the UE on the DSS carrier associated with the PCell as well as the non-DSS carrier associated with the SCell. For example, this may be beneficial due to a single DCI being used for cross carrier scheduling, rather than using multiple DCIs.

For example, one scenario may include the PCell (or another SCell) being associated with a 15 kHz DSS carrier and the SCell being associated with the 30 kHz non-DSS carrier, or some other carrier types/SCSs. The PCell typically has uplink resources available, while the SCell may not have uplink resources available (e.g., the SCell is configured for downlink only carrier aggregation). In one non-limiting example, both the PCell and the SCell may be operating in frequency range one (FR1). In one non-limiting example, the SCell may be associated with a NR unlicensed (NR-U) carrier.

Aspects of the described techniques include cross-carrier scheduling (CCS) from the SCell to the PCell. For example, DCIs from the PCell PDCCH may move to the SCell PDCCH. Such multi-carrier scheduling may improve operations at the PCell PDCCH using a single DCI instead of multiple DCIs (e.g., separate DCIs scheduling each CC). Non-DSS carrier scenarios may also be improved according to the described techniques.

Two DCI cases may be considered within the context of the described techniques. In case one, the DCI 205 may schedule data (e.g., PDSCH 210 on the CC of the SCell and PDSCH 215 on the CC of the PCell) and provides an indication of SCell dormancy (e.g., that CC(s) associated with a SCell that are dormant). In case two, the DCI may provide the indication of the SCell dormancy. In the situation where the DCI is a DCI scheduling PDSCHs over multiple CCs, the FDRA field of the DCI may be either separate fields for the CCs or a joint FRDA field for the CCs. The MCS, NDI, and RV fields may be separate fields for the CCs, while the HARQ and AP fields may be either joint or separate fields. Aspects of the described techniques may be implemented for the case two scenario (e.g., the DCI indicates the SCell dormancy).

For example, if the FDRA field of the DCI indicates an invalid value for one or more CCs, the DCI may be used to indicate SCell dormancy. For example, a base station (e.g., the SCell in this example) may determine that CC(s) associated with a UE are dormant. The UE may be configured with a plurality or set of CCs, but only some of which are dormant. Accordingly, the base station may set or otherwise configure a frequency resource allocation field (e.g., an FDRA field) of the DCI message 205 to indicate a value that is invalid for frequency resource allocations on at least one CC (e.g., a first CC). Broadly, a value that is invalid for frequency resource allocations may include the FDRA field being set to all “1s” or to all “0s,” or being set to a value or sequence that is not associated with frequency resource allocations. That is, the invalid indication may be any value or sequence of bits (e.g., using a bitmap) that is not otherwise used for frequency resource allocations.

The base station may also set or otherwise configure a subset of fields of the DCI message 205 to indicate information associated with the dormant CC(s). The subset of fields may include, but are not limited to, a first MCS field, a first NDI field, and a first RV field associated with a first CC in the DCI message 205 and a second MCS field, a second NDI field, and a second RV field associated with a second CC in the DCI message 205, e.g., separate fields. In some aspects, the subset of fields may include a HARQ field and AP (e.g., antenna port(s) field) of the DCI message may be joint fields or separate fields. In some aspects, the subset of fields may be used to indicate the dormant SCell(s). For example, the subset of fields may carry or otherwise convey information identifying the dormant SCell(s) (e.g., the CC(s) of a SCell that are dormant).

In some aspects, the subset of fields may include a resource allocation (RA) type field. In some aspects, the RA type field and FDRA field may joint indicate that DCI message 205 signals dormant SCell(s). For example, if the RA type “0” is used for a CC, then the corresponding FDRA field being set to all “0s” may convey the invalid indication. In another example, if the RA type “1” is used for a CC, then the corresponding FDRA field being set to all “1s” may convey the invalid indication.

If the invalid FDRA indication is only for one CC, among the MCS, NDI, RV, HARQ, and AP fields, the fields dedicatedly present for the CC are used to indicate the dormant SCell(s). That is, the separate fields, such as MCS, NDI, and RV associated with the CC corresponding to the invalid indication. If the invalid FDRA indication is for both CCs, all MCS, NDI, RV, HARQ, and AP fields may be used to indicate the dormant SCell(s). Accordingly, the base station may transmit or otherwise convey the DCI message 205 to the UE. The DCI message 205 may be configured according to the techniques discussed above.

The UE may receive the DCI message 205 from the base station and determine that the frequency resource allocation field (e.g., the FDRA) indicates a value that is invalid for frequency resource allocation. For example, the UE may recover (e.g., receive, successfully decode, and retrieve the entry from the FDRA field from the DCI message 205) the RA type field and FDRA field, determine that they are both set to all “0s” or all “1s,” and determine this indicates an invalid value. In some aspects, the UE may recover the FDRA field that is set to any value or sequence that is not otherwise associated with frequency resource allocations, which may provide the invalid indication. Based on the invalid indication, the UE may recover information from the subset of fields (e.g., MCS, NDI, RV, HARQ, AP, etc.) to identify the dormant SCell(s) (e.g., the dormant CC(s) associated with SCell(s)).

In some examples, aspects of the described techniques may be used for SPS/CG activation/release in addition to multi-CC scheduling. For example, the base station may transmit or otherwise convey a configuration of semi-persistent resources for the UE using a plurality of CCs. The semi-persistent resources may be SPS and/or CG resources.

In some aspects, DCI message 205 may be used to activate/release such SPS/CG resources. For example, if DCI message 205 is CRC scrambled by a cell specific radio network temporary identifier (CS-RNTI), then DCI message 205 is considered to be for SPS/CG activation/release. For a single SPS/CG resource, whether DCI message 205 is for activation or for release may be based on the FDRA field, in addition to the HARQ, RV, and MCS fields. For multiple SPS/CG resources, the HARQ field may be used to indicate the SPS index or CG index and activation/release may be based on the FDRA, RV and MCS fields. The NDI field being set to “1” to indicate that DCI message 205 is for activation/release, and be set to “0” if DCI message 205 is scheduling a retransmission. That is, the HARQ process number fields of DCI message 205 may be used to indicate the SPS/CG index when multiple SPS/CGs are being configured.

Accordingly, the base station may determine the activation status for the semi-persistent resources and configure the frequency resource allocation field (e.g., the FDRA field) of the DCI message 205 to indicate the value that is invalid for frequency resource allocation on at least one CC (e.g., CC1), as is discussed above. The base station may configure a subset of fields on DCI message 205 to include information identifying the dormant SCell(s) (e.g., CC(s)). The base station may transmit the DCI message 205 to the UE, which may use DCI message 205 to identify or otherwise determine dormant CC(s). That is, the UE may determine, for at least one CC (such as CC1), that the FDRA field indicates the value that is invalid for frequency resource allocation. Based on this invalid indication, the UE may determine the activation status for the semi-persistent resources.

In one non-limiting example wherein separate FDRA fields are used for the scheduled CCs, this may include setting the NDI field for the CC activating/releasing the SPS/CG to “0.” For an SPS/CG release indication for a CC, the FDRA field for the CC is an invalid value and the MCS field for the CC is set to all “1s,” the SPS/CG release indication for both CCs is possible by indicating invalid FDRA values for both CCs. If the HARQ process number field is a separate field and in the situation of single SPS/CG resource for the CC, the HARQ process number field and RV field for the CC with activation/release may be set to all “0s.” In the situation of multiple SPS/CG resources for the CC, the RV field for the CC with activation/release may be set to all “0s” and the HARQ field for the CC indicates the SPS/CG index to be activated or released.

If the HARQ process number field is a joint field, whether a single SPS/CG resource or multiple SPS/CG resources are configured, the HARQ process number field should be common between the CCs (e.g., set to a common or the same value). For a single SPS/CG resource, the HARQ process number field and the RV field for the CC with activation/release may be set to all “0s” and activation/release may be a common behavior for the two CCs. For multiple SPS/CG resources, the HARQ process number field may indicate the same SPS-index or CG-index for both of the CCs. Activation/release for a given SPS/CG index may be common behavior for the two CCs.

In another non-limiting example where a joint FDRA field is used for the scheduled CCs, this may include setting the NDI field for the CC activating/releasing the SPS/CG to “0.” The joint FDRA field may be (1) a configurable table with multiple columns for different CCs (and DCI message 205 may indicate one of rows of the table) or (2) a contiguous resource allocation over multiple CCs, etc. For an SPS/CG release indication for a CC, the FDRA field may be set to no resource for the CC and the MCS field for the CC may be set to all “1s.” An SPS/CG release indication for both CCs is possible by indicating no resource in the FDRA field for both CCs (e.g., an invalid indication).

If the HARQ process number field is a separate field, in the situation where a single SPS/CG resource for the CC is indicated, the HARQ process number field and the RV field for the CC with activation/release may be set to all “0s.” In the situation where multiple SPS/CG resources for the CC are indicated, the RV field for the CC with activation/release may be set to all “0s” and the HARQ process number field for the CC indicates the SPS/CG index to be activated or released.

If the HARQ process number field is a joint field, whether a single SPS/CG resource or multiple SPS/CG resources is/are configured may be common between the CCs. For a single SPS/CG resource, the HARQ process number field and RV field for the CC with activation/release may be set to all “0s.” The activation/release may be common behavior for the two CCs. For multiple SPSs/CGs resources, the HARQ field indicates the same SPS-index or CG-index for both of the CCs. The activation/release for a given SPS/CG index may be common behavior for the two CCs.

Accordingly, the UE may determine the activation status (e.g., activation/release) for the configured semi-persistent resources based on DCI message 205 received from the base station.

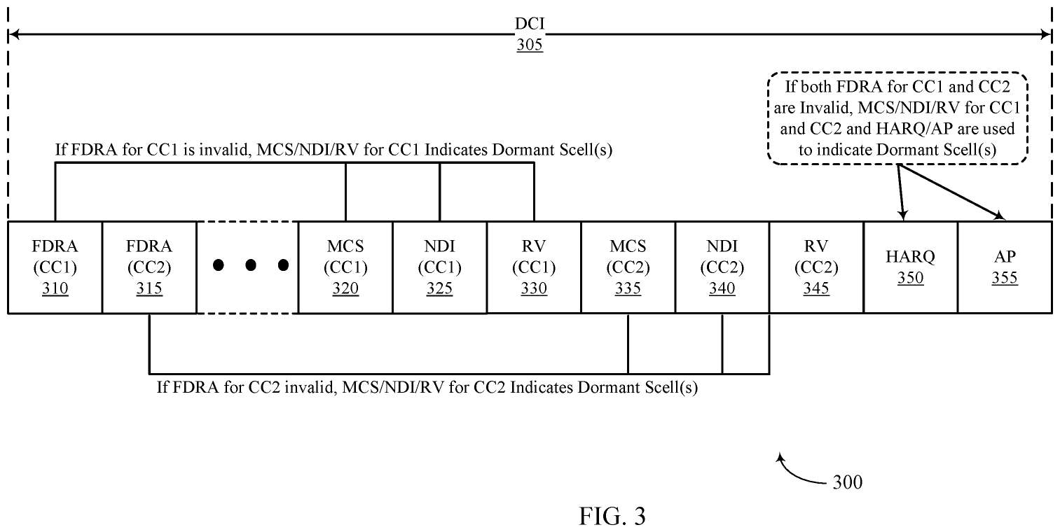

FIG. 3 illustrates an example of a DCI configuration 300 that supports secondary cell dormancy indication for scheduling multiple component carriers in accordance with aspects of the present disclosure. In some examples, DCI configuration 300 may implement aspects of wireless communication system 100 and/or CC configuration 200. Aspects of DCI configuration 300 may be implemented by a base station (e.g., a P/SCell) and/or a UE, which may be examples of the corresponding devices described herein.

As discussed above, aspects of the described techniques support SCell dormancy indication with multi-CC scheduling for a UE. For example, a base station may identify or otherwise determine that an SCell configured for the UE is dormant (e.g., CC(s) associated with the SCell). Accordingly, the base station may set or otherwise configure a frequency resource allocation field (e.g., a FDRA field) of a DCI message (e.g., DCI 305) to indicate a value that is invalid for frequency resource allocation on at least a first CC (e.g., CC1) based at least in part on the dormancy. The base station may also set or otherwise configure a subset of fields of the DCI message with information associated with the dormant CC(s), e.g., MCS, NID, RV, HARQ, AP, and the like. The base station may transmit or otherwise convey the DCI message (e.g., DCI 305) to the UE that is associated with scheduling transmissions for the UE on a plurality of CCs. The UE may use the DCI message to identify the dormant CC(s). For example, the UE may determine that the frequency resource allocation field indicates the invalid value, which may signal that the DCI message is a multi-CC scheduling DCI and includes the CC dormancy indication. The UE may then decode or otherwise recover the information of the subset of fields (e.g., identifying information) to determine which CC(s) are dormant.

As also discussed above, the DCI message may use either a separate FDRA fields for each CC or a joint FDRA field for each CC. DCI configuration 300 illustrates an example of a DCI message using separate FDRA fields per CC. For example, DCI 305 (e.g., the DCI message) may include a FDRA field 310 (e.g., a first frequency resource allocation field) associated with a first carrier (e.g., CC1), a FDRA field 315 associated with a second carrier (e.g., CC2). The FDRA field 310 may be set to an invalid indication if CC1 is dormant and/or the FDRA field 315 may be set to an invalid indication if CC2 is dormant. A value that is invalid for frequency resource allocation on a CC may be any value or sequence that is otherwise not associated with frequency resource allocations, e.g., all “0s,” all “1s,” or any other value/sequence that is not otherwise configured to allocate frequency resources.

DCI 305 may also include a MCS field 320, a NDI field 325, and a RV field 330 that are each associated with CC1. DCI 305 may also include a MCS field 335, a NDI field 340, and a RV field 345 that are each associated with CC2. If the FDRA field 310 is set to or otherwise indicates a value that is invalid for frequency resource allocation on CC1, the MCS field 320, the NDI field 325, and the RV field 330 may be set to or otherwise configured with information identifying CC1, e.g., the dormant SCell/CC. If the FDRA field 315 is set to or otherwise indicates a value that is invalid for frequency resource allocation on CC2, the MCS field 335, the NDI field 340, and the RV field 345 may be set to or otherwise configured with information identifying CC2, e.g., the dormant SCell/CC. If both FDRA fields 310 and 315 are set to values that are invalid for frequency resource allocations, then each respective MCS/NDURV field may be configured with identifying information of the respective SCell/CC.

DCI 305 may also include a HARQ field 350 and an AP field 355. If one of the FDRA fields are set to a value that is invalid for frequency resource allocation, the HARQ field 350 and AP field 355 may be used for their original purpose (e.g., to indicate HARQ/AP information). However, if both FDRA fields are set to values that are invalid for frequency resource allocations, the HARQ field 350 and AP fields 355 may be configured with information associated with the dormant CC1 and CC2. For example, the HARQ field 350 and AP field 355 may provide the addition of further information identifying the dormant SCells/CCs, e.g., used as extra bits to identify the dormant SCells/CCs. In one example, the HARQ field 350 and AP field 355 may be used to indicate additional information regarding the dormancy, e.g., timing information.

In some aspects, this may include when the FDRA field 310 for CC1 indicates an invalid value, the MCS field 320 for CC1, the NDI field 325 for CC1, and the RV field 330 for CC1 provides a bitmap to each configured dormant SCell/CC In some examples, the bitmap may be in an ascending order of the SCell index. A “0” value for a bit of the bitmap may indicate an active downlink bandwidth part (BWP), that is provided by dormant-BWP, for the UE for a corresponding activated SCell. A “1” value for a bit of the bitmap may indicate an active downlink BWP, that is provided by a first-non-dormant-BWP-identifier (ID)-for-DCI-inside-active-time, for the UE for a corresponding activated SCell/CC, if a current active downlink BWP is the dormant downlink BWP. A “1” value for a bit of the bitmap may indicate a currently active downlink BWP, for the UE for a corresponding activated SCell, if the current active downlink BWP is not the dormant DL BWP. The UE sets the active downlink BWP to the indicated active downlink BWP.

If the FDRA field 315 for CC2 indicates an invalid value, the MCS field 335 for CC2, the NDI field 340 for CC2, and the RV field 345 for CC2 provides a bitmap to each configured SCell, in an ascending order of the SCell index, similar to the FDRA field 310 for CC1 indicating an invalid value. If the FDRA fields 310/315 for both CC1 and CC2 indicate invalid value(s), the MCS field 320 for CC1, the NDI field 325 for CC1, the RV field 330 for CC1, the MCS field 335 for CC2, the NDI field 340 for CC2, the RV field 345 for CC2, the HARQ field 350, and the AP field 355 may provide a bitmap to each configured SCell, in an ascending order of the SCell index, similar to if the FDRA field for CC1 indicates an invalid value, e.g., joint field(s) may be involved in the bitmap only if both CC1 and CC2 has no valid FDRA field values.

Accordingly, the UE may receive the DCI message (e.g., DCI 305) and use the information indicated in the respective fields to identify the dormant SCell(s)/CC(s).

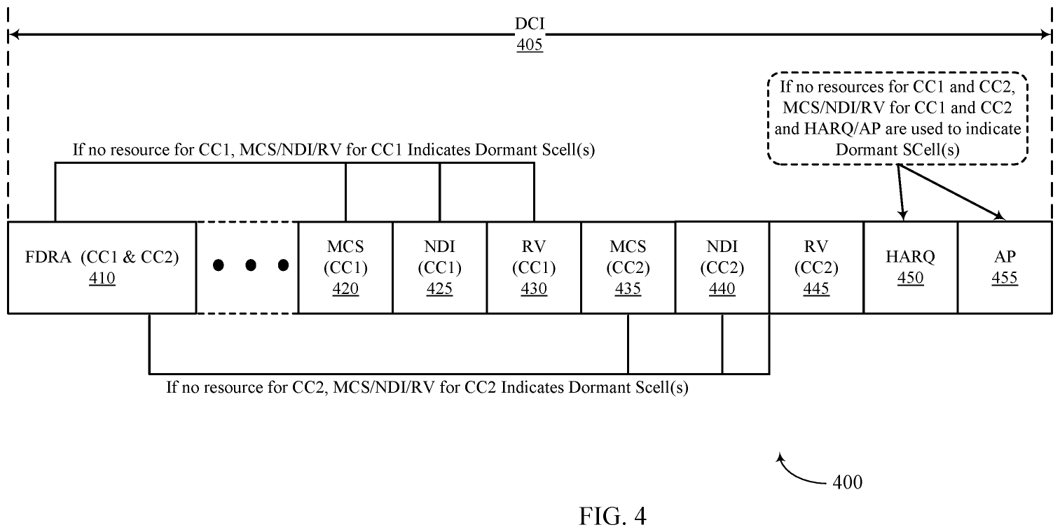

FIG. 4 illustrates an example of a DCI configuration 400 that supports secondary cell dormancy indication for scheduling multiple component carriers in accordance with aspects of the present disclosure. In some examples, DCI configuration 400 may implement aspects of wireless communication system 100, CC configuration 200, and/or DCI configuration 300. Aspects of DCI configuration 400 may be implemented by a base station (e.g., a P/SCell) and/or a UE, which may be examples of the corresponding devices described herein.

As discussed above, aspects of the described techniques support SCell dormancy indication with multi-CC scheduling for a UE. For example, a base station may identify or otherwise determine that an SCell configured for the UE is dormant (e.g., CC(s) associated with the SCell). Accordingly, the base station may set or otherwise configure a frequency resource allocation field (e.g., a FDRA field) of a DCI message (e.g., DCI 405) to indicate a value that is invalid for frequency resource allocation on at least a first CC (e.g., CC1) based at least in part on the dormancy. The base station may also set or otherwise configure a subset of fields of the DCI message with information associated with the dormant CC(s), e.g., MCS, NID, RV, HARQ, AP, and the like. The base station may transmit or otherwise convey the DCI message (e.g., DCI 405) to the UE that is associated with scheduling transmissions for the UE on a plurality of CCs. The UE may use the DCI message to identify the dormant CC(s). For example, the UE may determine that the frequency resource allocation field indicates the invalid value, which may signal that the DCI message is a multi-CC scheduling DCI and includes the CC dormancy indication. The UE may then decode or otherwise recover the information of the subset of fields (e.g., identifying information) to determine which CC(s) are dormant.

As also discussed above, the DCI message may use either a separate FDRA fields for each CC or a joint FDRA field for each CC. DCI configuration 400 illustrates an example of a DCI message using a joint FDRA field. For example, DCI 405 (e.g., the DCI message) may include a FDRA field 410 associated with CC1 and CC2. The FDRA field 410 (e.g., a joint frequency resource allocation field) may be set to an invalid indication if CC1 and/or CC2 are dormant. A value that is invalid for frequency resource allocation on a CC may be any value or sequence that is otherwise not associated with frequency resource allocations, e.g., all “0s,” all “1s,” or any other value/sequence that is not otherwise configured to allocate frequency resources.

In some aspects, the FDRA field 410 could be a configurable table with multiple columns for different CCs where the FDRA field 410 may indicate one of the rows of the table, a contiguous resource allocation over multiple CCs, and the like. If the FDRA field 410 indicates no resource in/for a CC, the respective MCS, NDI, RV, HARQ, and AP, the field(s) dedicated for the CC(s) may be used to indicate the dormant SCell(s)/CC(s). If the FDRA field 410 indicates no resource in/for both CCs, all MCS, NDI, RV, HARQ, and AP field(s) may be used to indicate dormant SCell(s).

For example, DCI 405 may also include a MCS field 420, a NDI field 425, and a RV field 430 that are each associated with CC1. DCI 405 may also include a MCS field 435, a NDI field 440, and a RV field 445 that are each associated with CC2. If the FDRA field 410 is set to or otherwise indicates a value that is invalid for frequency resource allocation on CC1, the MCS field 420, the NDI field 425, and the RV field 430 may be set to or otherwise configured with information identifying CC1, e.g., the dormant SCell/CC. If the FDRA field 410 is set to or otherwise indicates a value that is invalid for frequency resource allocation on CC2, the MCS field 435, the NDI field 440, and the RV field 445 may be set to or otherwise configured with information identifying CC2, e.g., the dormant SCell/CC. If FDRA field 410 is set to a value that are invalid for frequency resource allocations on CC1 and CC2, then each respective MCS/NDI/RV field may be configured with identifying information of the respective SCell/CC.

DCI 405 may also include a HARQ field 450 and an AP field 455. If the FDRA field 410 is set to a value that is invalid for frequency resource allocation on CC1 or CC2, the HARQ field 450 and AP field 455 may be used for their original purpose (e.g., to indicate HARQ/AP information). However, if FDRA field 410 is set to a value that is invalid for frequency resource allocations on CC1 and CC2, the HARQ field 450 and AP fields 455 may be configured with information associated with the dormant CC1 and CC2. For example, the HARQ field 450 and AP field 455 may provide the addition of further information identifying the dormant SCells/CCs, e.g., used as extra bits to identify the dormant SCells/CCs. In one example, the HARQ field 450 and AP field 455 may be used to indicate additional information regarding the dormancy, e.g., timing information.

Accordingly, the UE may receive the DCI message (e.g., DCI 305) and use the information indicated in the respective fields to identify the dormant SCell(s)/CC(s).

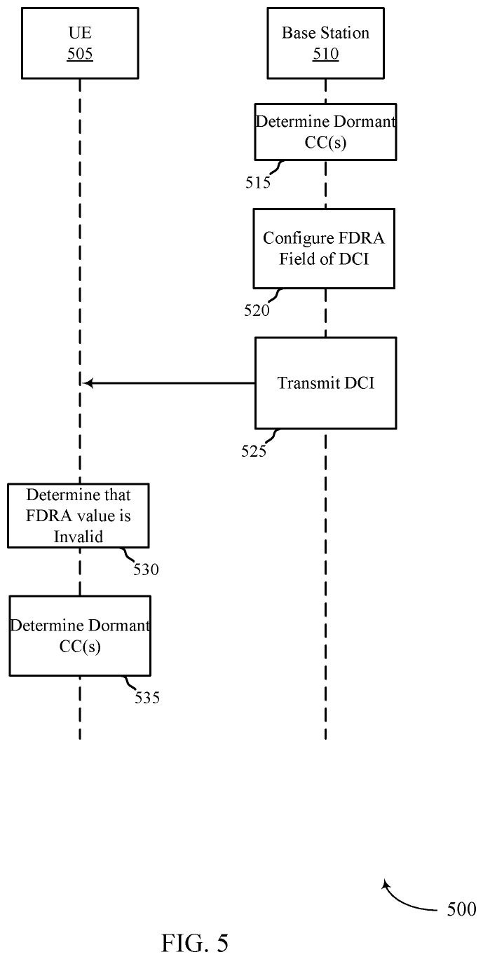

FIG. 5 illustrates an example of a process 500 that supports secondary cell dormancy indication for scheduling multiple component carriers in accordance with aspects of the present disclosure. In some examples, process 500 may implement aspects of wireless communication system 100, CC configuration 200, and/or DCI configurations 300 and/or 400. Aspects of process 500 may be implemented by UE 505 and/or base station 510, which may be examples of the corresponding devices described herein.

At 515, base station 510 may identify or otherwise determine, for UE 505, that one or more CCs of a plurality of CCs that are dormant.

At 520, base station 510 may set or otherwise configure a frequency resource allocation field (e.g., separate FDRA fields or a joint FDRA field) of a DCI message to indicate a value that is invalid for frequency resource allocation on at least a first CC of the plurality of CCs. Base station 510 may also set of otherwise configure a subset of fields of the DCI message indicating information associated with the dormant one or more CCs (e.g., MCS field(s), NDI field(s), RV field(s), a HARQ field, an AP field, a RA type field, and the like). In some aspects, this may include the FDRA field(s) being set to an invalid value to indicate that the DCI message indicates SCell/CC dormancy and then subset of fields conveying identifying information for the dormant SCell(s)/CC(s).

In some aspects, this may include base station 510 setting a bit in a RA type field in the DCI message to a first value (e.g., a “1” or a “0.” Base station 510 may set each bit in a bitmap indicated in the frequency resource allocation field associated with the first CC in the DCI message to the first value (e.g., all “1s” or all “0s.” In some aspects, the value being invalid for frequency resource allocation on the first CC may be based at least in part on each bit in the bitmap being set to the first value, e.g., each bit in the FDRA field being set to the same value as is set for the RA type field.

In some aspects, this may include base station 510 configuring the subset of fields of the DCI message to indicate information identifying the dormant one or more CCs of the plurality of CCs. Base station 510 may map each bit of a bitmap indicated in the subset of fields to a CC of the plurality of CCs. In some aspects, a value of each bit and the mapping may indicate that the CC is active or dormant.

In some aspects, this may include base station 510 configuring the frequency resource allocation field of the DCI message associated with a second CC to indicate the value that is invalid for frequency resource allocation on the second CC. For example, base station 510 may set a bit in a RA type field associated with the second CC in the DCI message to a first value and set each bit in a bitmap in the frequency resource allocation field associated with the second CC in the DCI message to the first value. In some aspects, the value being invalid for frequency resource allocation on the second CC may be based at least in part on each bit in the bitmap being set to the first value. Base station 510 may configure the subset of fields associated with the first CC in the DCI message (e.g., MCS/NDI/RV fields associated with CC1), a second subset of fields associated with the second CC in the DCI message (e.g., MCS/NDI/RV fields associated with CC1), and a common subset of fields in the DCI message (e.g., HARQ/AP fields), to indicate information associated with the dormant one or more CCs of the plurality of CCs. Base station 510 may map each bit of a bitmap indicated in the subset of fields, the second subset of fields, and the common subset of fields, to a CC of the plurality of CCs. In some aspects, a value of each bit and the mapping may indicate that the CC is active or dormant.

In some aspects, this may include base station 510 configuring a joint frequency resource allocation field to indicate that no resources are allocated to the first CC. In some aspects, the value being invalid for frequency resource allocation on the first CC may be based at least in part on no resources allocated to the first CC. Base station 510 may configure the subset of fields of the DCI message to indicate information identifying the dormant one or more CCs of the plurality of CCs. For example, base station 510 may map each bit of a bitmap indicated in the subset of fields to a CC of the plurality of CCs and set a value of each bit in the bitmap to indicate that the CC is active or dormant.

At 525, base station 510 may transmit (and UE 505 may receive) the configured DCI message.

At 530, UE 505 may determine, for at least the first CC of the plurality of CCs, that a frequency resource allocation field of the DCI message includes an indication of a value that is invalid for frequency resource allocation on the first CC. In some aspects, this may include UE 505 determining that a bit in a RA type field in the DCI message is set to a first value and determining that each bit in a bitmap indicated in the frequency resource allocation field associated with the first CC in the DCI message are set to the first value. In some aspects, the value being invalid for frequency resource allocation on the first CC may be based at least in part on each bit in the bitmap being set to the first value.

At 535, UE 505 may determine, based at least in part on the invalid indication and using the subset of fields of the DCI message corresponding to the first CC, that one or more CCs of the plurality of component carriers are dormant. For example, UE 505 may identify, based at least in part on the subset of fields of the DCI message, the dormant one or more CCs of the plurality of CCs.

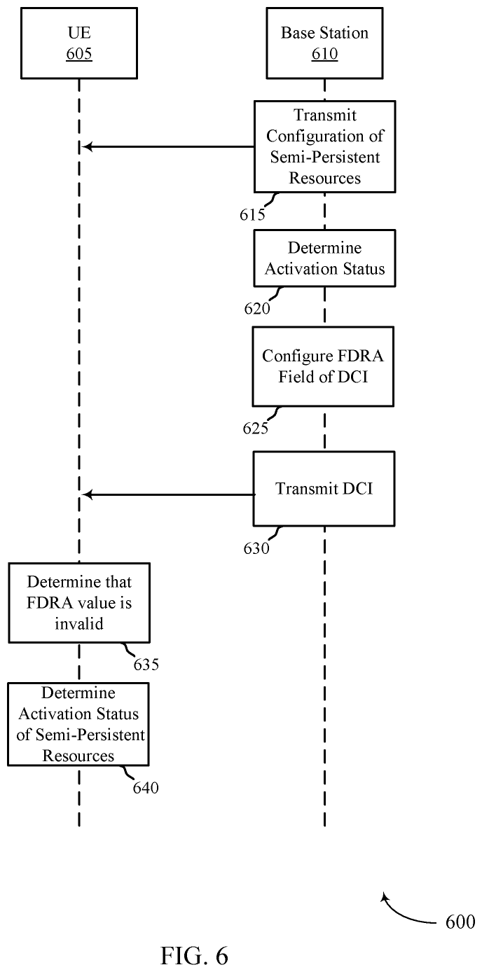

FIG. 6 illustrates an example of a process 600 that supports secondary cell dormancy indication for scheduling multiple component carriers in accordance with aspects of the present disclosure. In some examples, process 600 may implement aspects of wireless communication system 100, CC configuration 200, and/or DCI configurations 300 and/or 400. Aspects of process 600 may be implemented by UE 605 and/or base station 610, which may be examples of the corresponding devices described herein.

At 615, base station 610 may transmit (and UE 605 may receive) a configuration of semi-persistent resources for UE 605 using a plurality of CCs. The semi-persistent resources may be SPS resources and/or CG resources.

At 620, base station 610 may determine an activation status for the semi-persistent resources, e.g., whether the resources are active or released.

At 625, base station 610 may configure, for at least a first CC of the plurality of CCs and the activation status, a frequency resource allocation field of a DCI message to indicate a value that is invalid for frequency resource allocation on the first CC.

In some aspects, this may include base station 610 configuring a separate HARQ process number field in the DCI message for each CC in the plurality of CCs. For example, base station 610 may configure each bit in the HARQ process number field and a RV field of the DCI message to indicate the activation status for a semi-persistent resource associated with the first CC. Base station 610 may set each bit in a RV field to a first value based at least in part on the activation status for a plurality of semi-persistent resources associated with the first CC. In some aspects, an identity of the plurality of semi-persistent resources may be based at least in part on the HARQ process number field.

In some aspects, this may include base station 610 configuring the joint HARQ process number field and a RV field in the DCI message based at least in part on the activation status for a semi-persistent resource associated with the first CC. Base station 610 may set each bit in a RV field to a first value based at least in part on the activation status for a plurality of semi-persistent resources associated with the first CC. In some aspects, the semi-persistent resources associated with the first CC may be identified based at least in part on the joint HARQ process number field.

At 630, base station 610 may transmit (and UE 605 may receive) the DCI message conveying the invalid indication. In some aspects, the DCI message may include a separate frequency resource allocation field for each CC of the plurality of CCs or a joint frequency resource allocation field for the plurality of CCs.

At 635, UE 605 may determine, for at least the first CC (e.g., CC1 or CC2) of the plurality of CCs, that a frequency resource allocation field of the DCI message indicates a value that is invalid for frequency resource allocation on the first CC.

At 640, UE 605 may determine the activation status for the semi-persistent resources based at least in part on the invalid indication. For example, UE 605 may determine that the DCI message includes a separate HARQ process number field for each CC in the plurality of CCs. UE 605 may determine the activation status for a semi-persistent resource associated with the first CC based at least in part on each bit in the HARQ process number field and a RV field being set to a first value. UE 605 may determine the activation status for a plurality of semi-persistent resources associated with the first CC based at least in part on each bit in a RV field being set to a first value and identify the plurality of semi-persistent resources based at least in part on the HARQ process number field.

In some aspects, this may include UE 605 determining that the DCI message includes a joint HARQ process number field for each CC in the plurality of CCs. UE 605 may determine the activation status for a semi-persistent resource associated with the first CC based at least in part on each bit in the HARQ process number field and a RV field being set to a first value. UE 605 may determine the activation status for a plurality of semi-persistent resources associated with the first CC based at least in part on each bit in a RV field being set to a first value and identify the plurality of semi-persistent resources associated with the first CC and a second CC based at least in part on the HARQ process number field.

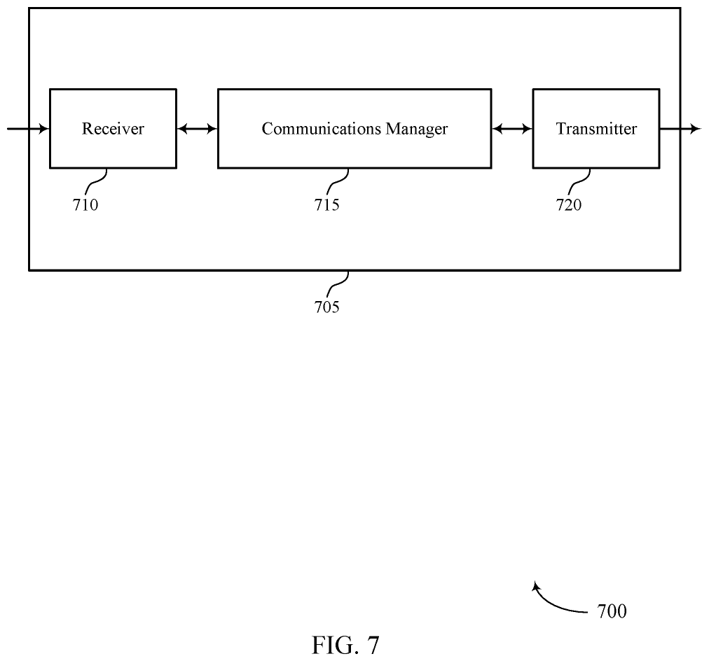

FIG. 7 shows a block diagram 700 of a device 705 that supports secondary cell dormancy indication for scheduling multiple CCs in accordance with aspects of the present disclosure. The device 705 may be an example of aspects of a UE 115 as described herein. The device 705 may include a receiver 710, a communications manager 715, and a transmitter 720. The device 705 may also include a processor. Each of these components may be in communication with one another (e.g., via one or more buses).

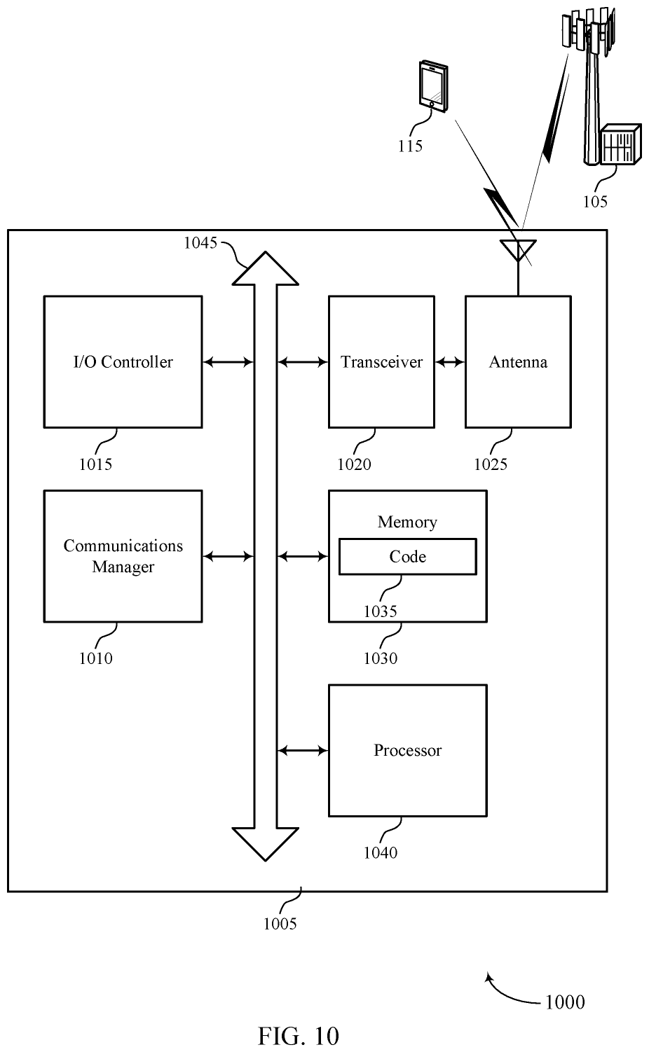

The receiver 710 may receive information such as packets, user data, or control information associated with various information channels (e.g., control channels, data channels, and information related to secondary cell dormancy indication for scheduling multiple CCs, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may receive, from a base station, a DCI message associated with scheduling transmissions for the UE on a set of CCs, determine, for at least a first CC of the set of CCs, that a frequency resource allocation field of the DCI message includes an indication of a value that is invalid for frequency resource allocation on the first CC, and determine, based on the invalid indication and using a subset of fields of the DCI message corresponding to the first CC, that one or more CCs of the set of CCs are dormant.

The communications manager 715 may also receive a configuration of semi-persistent resources for the UE using a set of CCs, determine, based on the invalid indication, an activation status for the semi-persistent resources, receive, from a base station, a DCI message associated with scheduling transmissions for the UE on the set of CCs, and determine, for at least a first CC of the set of CCs, that a frequency resource allocation field of the DCI message includes an indication of a value that is invalid for frequency resource allocation on the first CC. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

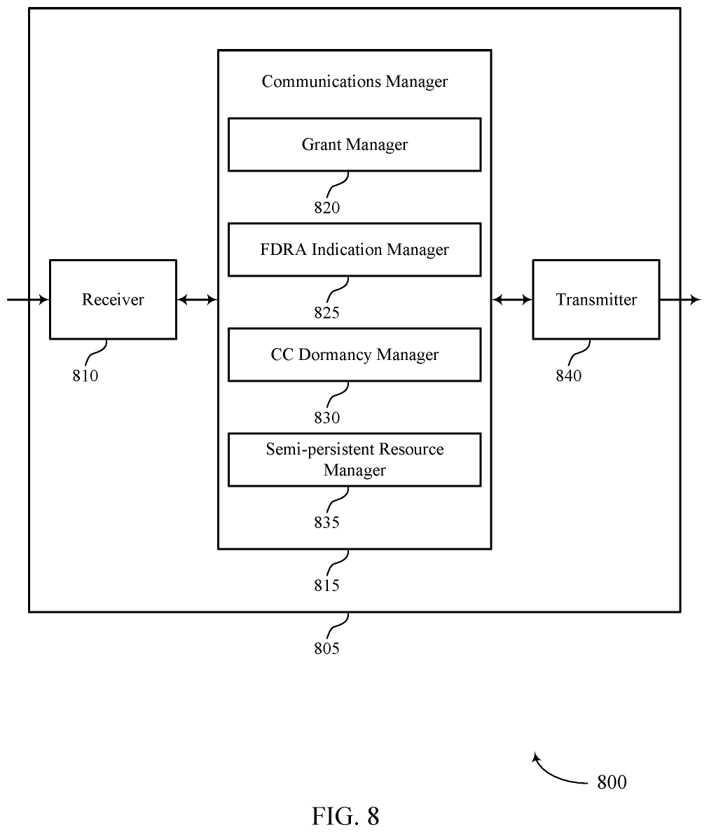

FIG. 8 shows a block diagram 800 of a device 805 that supports secondary cell dormancy indication for scheduling multiple CCs in accordance with aspects of the present disclosure. The device 805 may be an example of aspects of a device 705, or a UE 115 as described herein. The device 805 may include a receiver 810, a communications manager 815, and a transmitter 840. The device 805 may also include a processor. Each of these components may be in communication with one another (e.g., via one or more buses).

The receiver 810 may receive information such as packets, user data, or control information associated with various information channels (e.g., control channels, data channels, and information related to secondary cell dormancy indication for scheduling multiple CCs, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a grant manager 820, a FDRA indication manager 825, a CC dormancy manager 830, and a semi-persistent resource manager 835. The communications manager 815 may be an example of aspects of the communications manager 1010 described herein.

The grant manager 820 may receive, from a base station, a DCI message associated with scheduling transmissions for the UE on a set of CCs.

The FDRA indication manager 825 may determine, for at least a first CC of the set of CCs, that a frequency resource allocation field of the DCI message includes an indication of a value that is invalid for frequency resource allocation on the first CC.

The CC dormancy manager 830 may determine, based on the invalid indication and using a subset of fields of the DCI message corresponding to the first CC, that one or more CCs of the set of CCs are dormant.

The semi-persistent resource manager 835 may receive a configuration of semi-persistent resources for the UE using a set of CCs and determine, based on the invalid indication, an activation status for the semi-persistent resources.

The grant manager 820 may receive, from a base station, a DCI message associated with scheduling transmissions for the UE on the set of CCs.

The FDRA indication manager 825 may determine, for at least a first CC of the set of CCs, that a frequency resource allocation field of the DCI message includes an indication of a value that is invalid for frequency resource allocation on the first CC.

The transmitter 840 may transmit signals generated by other components of the device 805. In some examples, the transmitter 840 may be collocated with a receiver 810 in a transceiver module. For example, the transmitter 840 may be an example of aspects of the transceiver 1020 described with reference to FIG. 10. The transmitter 840 may utilize a single antenna or a set of antennas.

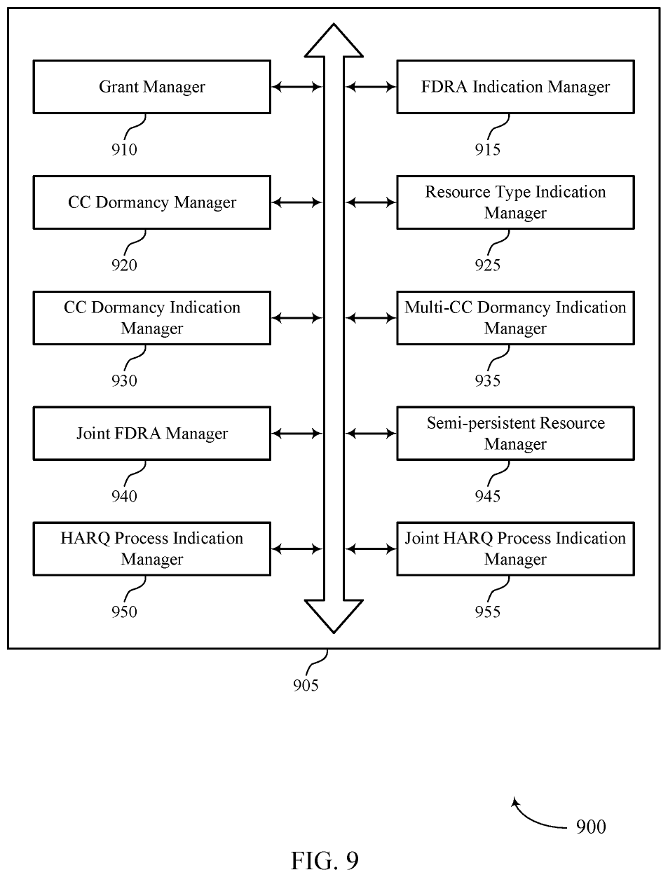

FIG. 9 shows a block diagram 900 of a communications manager 905 that supports secondary cell dormancy indication for scheduling multiple CCs in accordance with aspects of the present disclosure. The communications manager 905 may be an example of aspects of a communications manager 715, a communications manager 815, or a communications manager 1010 described herein. The communications manager 905 may include a grant manager 910, a FDRA indication manager 915, a CC dormancy manager 920, a resource type indication manager 925, a CC dormancy indication manager 930, a multi-CC dormancy indication manager 935, a joint FDRA manager 940, a semi-persistent resource manager 945, a HARQ process indication manager 950, and a joint HARQ process indication manager 955. Each of these modules may communicate, directly or indirectly, with one another (e.g., via one or more buses).

The grant manager 910 may receive, from a base station, a DCI message associated with scheduling transmissions for the UE on a set of CCs. In some cases, the subset of fields of the DCI message include one or more of a MCS field, a NDI field, or a RV field. In some cases, the DCI message includes at least one of a separate frequency resource allocation field for each CC of the set of CCs or a joint frequency resource allocation field for the set of CCs.

The FDRA indication manager 915 may determine, for at least a first CC of the set of CCs, that a frequency resource allocation field of the DCI message includes an indication of a value that is invalid for frequency resource allocation on the first CC. In some examples, determining, for at least a first CC of the set of CCs, that a frequency resource allocation field of the DCI message includes an indication of a value that is invalid for frequency resource allocation on the first CC.

The CC dormancy manager 920 may determine, based on the invalid indication and using a subset of fields of the DCI message corresponding to the first CC, that one or more CCs of the set of CCs are dormant.

The semi-persistent resource manager 945 may receive a configuration of semi-persistent resources for the UE using a set of CCs. In some examples, the semi-persistent resource manager 945 may determine, based on the invalid indication, an activation status for the semi-persistent resources.

The resource type indication manager 925 may determine that a bit in a resource allocation type field in the DCI message is set to a first value. In some examples, the resource type indication manager 925 may determine that each bit in a bitmap indicated in the frequency resource allocation field associated with the first CC in the DCI message are set to the first value, where the value being invalid for frequency resource allocation on the first CC is based on each bit in the bitmap being set to the first value.

The CC dormancy indication manager 930 may identify, based on the subset of fields of the DCI message, the dormant one or more CCs of the set of CCs. In some examples, the CC dormancy indication manager 930 may map each bit of a bitmap indicated in the subset of fields to a CC of the set of CCs. In some examples, the CC dormancy indication manager 930 may determine, based on a value of each bit and the mapping, that the CC is active or dormant.

The multi-CC dormancy indication manager 935 may determine, for at least a second CC of the set of CCs, that the frequency resource allocation field of the DCI message associated with the second CC includes an indication of a value that is invalid for frequency resource allocation on the second CC. In some examples, the multi-CC dormancy indication manager 935 may determine that a bit in a resource allocation type field associated with the second CC in the DCI message is set to a first value.

In some examples, the multi-CC dormancy indication manager 935 may determine that each bit in a bitmap in the frequency resource allocation field associated with the second CC in the DCI message are set to the first value, where the value being invalid for frequency resource allocation on the second CC is based on each bit in the bitmap being set to the first value. In some examples, the multi-CC dormancy indication manager 935 may identify, based on the subset of fields associated with the first CC in the DCI message, a second subset of fields associated with the second CC in the DCI message, and a common subset of fields in the DCI message, the dormant one or more CCs of the set of CCs.

In some examples, the multi-CC dormancy indication manager 935 may map each bit of a bitmap indicated in the subset of fields, the second subset of fields, and the common subset of fields, to a CC of the set of CCs. In some examples, the multi-CC dormancy indication manager 935 may determine, based on a value of each bit and the mapping, that the CC is active or dormant.

The joint FDRA manager 940 may determine, based on the joint frequency resource allocation field, that no resources are allocated to the first CC, where the value being invalid for frequency resource allocation on the first CC is based on no resources allocated to the first CC. In some examples, the joint FDRA manager 940 may identify, based on the subset of fields of the DCI message, the dormant one or more CCs of the set of CCs.

In some examples, the joint FDRA manager 940 may map each bit of a bitmap indicated in the subset of fields to a CC of the set of CCs. In some examples, the joint FDRA manager 940 may determine, based on a value of each bit and the mapping, that the CC is active or dormant.

In some examples, the joint FDRA manager 940 may determine, for at least the second CC of the set of CCs, that no resources are allocated to the second CC, where the value being invalid for frequency resource allocation on the second CC is based on no resources allocated to the second CC. In some examples, the joint FDRA manager 940 may identify, based on the subset of fields associated with the first CC in the DCI message, a second subset of fields associated with the second CC in the DCI message, and a common subset of fields in the DCI message, the dormant one or more CCs of the set of CCs.

In some examples, the joint FDRA manager 940 may map each bit of a bitmap indicated in the subset of fields, the second subset of fields, and the common subset of fields, to a CC of the set of CCs. The HARQ process indication manager 950 may determine that the DCI message includes a separate HARQ process number field for each CC in the set of CCs. In some examples, the HARQ process indication manager 950 may determine the activation status for a semi-persistent resource associated with the first CC based on each bit in the HARQ process number field and a redundancy version field being set to a first value. In some examples, the HARQ process indication manager 950 may determine the activation status for a set of semi-persistent resources associated with the first CC based on each bit in a redundancy version field being set to a first value. In some examples, the HARQ process indication manager 950 may identify the set of semi-persistent resources based on the HARQ process number field.

The joint HARQ process indication manager 955 may determine that the DCI message includes a joint HARQ process number field for each CC in the set of CCs. In some examples, the joint HARQ process indication manager 955 may determine the activation status for a semi-persistent resource associated with the first CC based on each bit in the HARQ process number field and a redundancy version field being set to a first value.

In some examples, the joint HARQ process indication manager 955 may determine the activation status for a set of semi-persistent resources associated with the first CC based on each bit in a redundancy version field being set to a first value. In some examples, the joint HARQ process indication manager 955 may identify the set of semi-persistent resources associated with the first CC and a second CC based on the HARQ process number field.

FIG. 10 shows a diagram of a system 1000 including a device 1005 that supports secondary cell dormancy indication for scheduling multiple CCs in accordance with aspects of the present disclosure. The device 1005 may be an example of or include the components of device 705, device 805, or a UE 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may receive, from a base station, a DCI message associated with scheduling transmissions for the UE on a set of CCs, determine, for at least a first CC of the set of CCs, that a frequency resource allocation field of the DCI message includes an indication of a value that is invalid for frequency resource allocation on the first CC, and determine, based on the invalid indication and using a subset of fields of the DCI message corresponding to the first CC, that one or more CCs of the set of CCs are dormant.

The communications manager 1010 may also receive a configuration of semi-persistent resources for the UE using a set of CCs, determine, based on the invalid indication, an activation status for the semi-persistent resources, receive, from a base station, a DCI message associated with scheduling transmissions for the UE on the set of CCs, and determine, for at least a first CC of the set of CCs, that a frequency resource allocation field of the DCI message includes an indication of a value that is invalid for frequency resource allocation on the first CC.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include random access memory (RAM) and read-only memory (ROM). The memory 1030 may store computer-readable, computer-executable code 1035 including instructions that, when executed, cause the processor to perform various functions described herein. In some cases, the memory 1030 may contain, among other things, a basic input/output system (BIOS) which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting secondary cell dormancy indication for scheduling multiple CCs).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

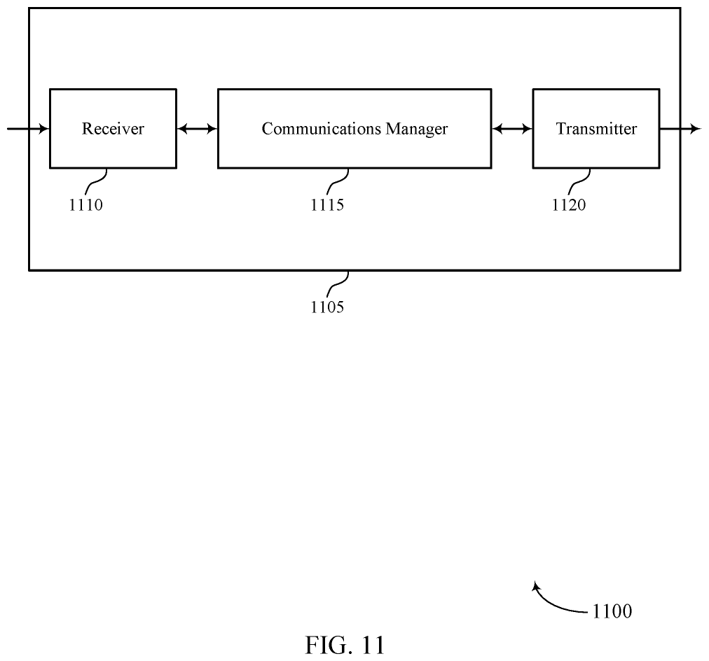

FIG. 11 shows a block diagram 1100 of a device 1105 that supports secondary cell dormancy indication for scheduling multiple CCs in accordance with aspects of the present disclosure. The device 1105 may be an example of aspects of a base station 105 as described herein. The device 1105 may include a receiver 1110, a communications manager 1115, and a transmitter 1120. The device 1105 may also include a processor. Each of these components may be in communication with one another (e.g., via one or more buses).

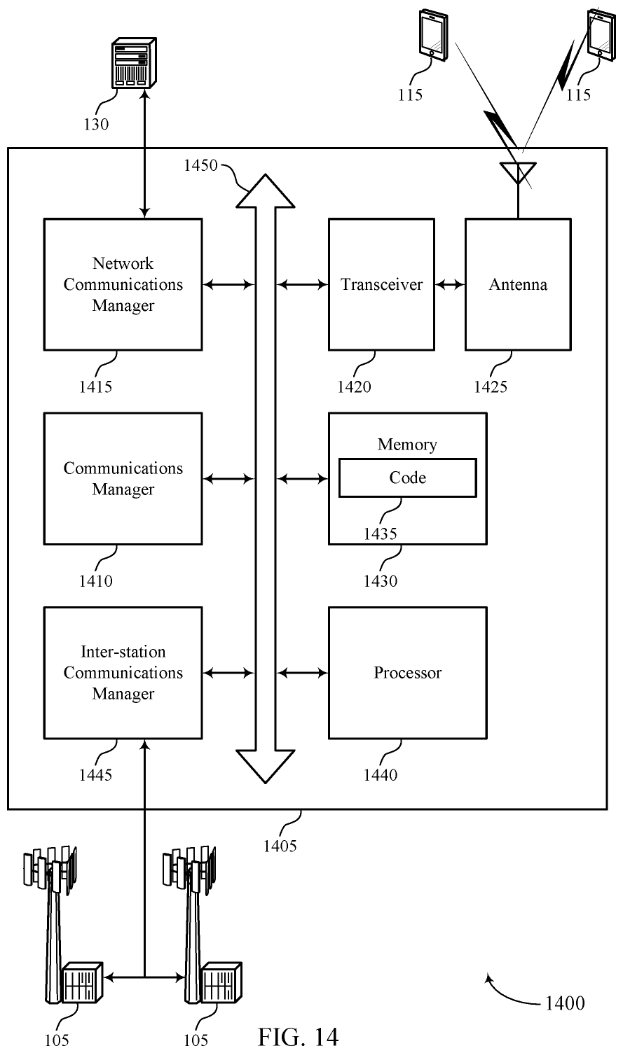

The receiver 1110 may receive information such as packets, user data, or control information associated with various information channels (e.g., control channels, data channels, and information related to secondary cell dormancy indication for scheduling multiple CCs, etc.). Information may be passed on to other components of the device 1105. The receiver 1110 may be an example of aspects of the transceiver 1420 described with reference to FIG. 14. The receiver 1110 may utilize a single antenna or a set of antennas.

The communications manager 1115 may determine, for a UE, that one or more CCs of a set of CCs that are dormant, configure a frequency resource allocation field of a DCI message to indicate a value that is invalid for frequency resource allocation on at least a first CC of the set of CCs and a subset of fields of the DCI message indicating information associated with the dormant one or more CCs, and transmit, to the UE, the DCI message associated with scheduling transmissions for the UE on the set of CCs.

The communications manager 1115 may also transmit, to a UE, a configuration of semi-persistent resources for the UE using a plurality of CCs, determine an activation status for the semi-persistent resources, configure, for at least a first CC of the set of CCs and the activation status, a frequency resource allocation field of a DCI message to indicate a value that is invalid for frequency resource allocation on the first CC, and transmit the DCI message to the UE conveying the invalid indication. The communications manager 1115 may be an example of aspects of the communications manager 1410 described herein.

The communications manager 1115, or its sub-components, may be implemented in hardware, code (e.g., software or firmware) executed by a processor, or any combination thereof. If implemented in code executed by a processor, the functions of the communications manager 1115, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The communications manager 1115, or its sub-components, may be physically located at various positions, including being distributed such that portions of functions are implemented at different physical locations by one or more physical components. In some examples, the communications manager 1115, or its sub-components, may be a separate and distinct component in accordance with various aspects of the present disclosure. In some examples, the communications manager 1115, or its sub-components, may be combined with one or more other hardware components, including but not limited to an I/0 component, a transceiver, a network server, another computing device, one or more other components described in the present disclosure, or a combination thereof in accordance with various aspects of the present disclosure.

The transmitter 1120 may transmit signals generated by other components of the device 1105. In some examples, the transmitter 1120 may be collocated with a receiver 1110 in a transceiver module. For example, the transmitter 1120 may be an example of aspects of the transceiver 1420 described with reference to FIG. 14. The transmitter 1120 may utilize a single antenna or a set of antennas.

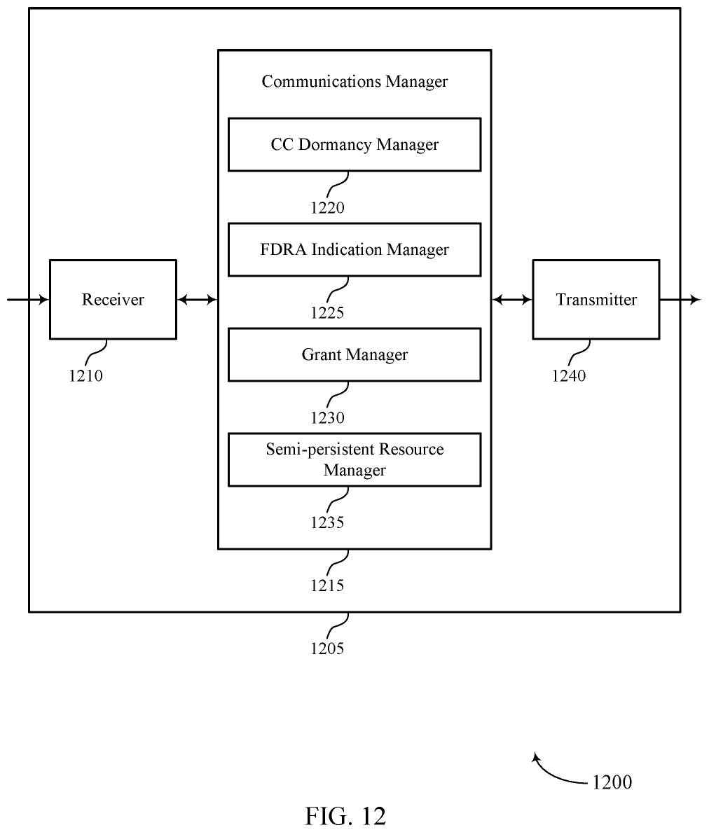

FIG. 12 shows a block diagram 1200 of a device 1205 that supports secondary cell dormancy indication for scheduling multiple CCs in accordance with aspects of the present disclosure. The device 1205 may be an example of aspects of a device 1105, or a base station 105 as described herein. The device 1205 may include a receiver 1210, a communications manager 1215, and a transmitter 1240. The device 1205 may also include a processor. Each of these components may be in communication with one another (e.g., via one or more buses).

The receiver 1210 may receive information such as packets, user data, or control information associated with various information channels (e.g., control channels, data channels, and information related to secondary cell dormancy indication for scheduling multiple CCs, etc.). Information may be passed on to other components of the device 1205. The receiver 1210 may be an example of aspects of the transceiver 1420 described with reference to FIG. 14. The receiver 1210 may utilize a single antenna or a set of antennas.

The communications manager 1215 may be an example of aspects of the communications manager 1115 as described herein. The communications manager 1215 may include a CC dormancy manager 1220, a FDRA indication manager 1225, a grant manager 1230, and a semi-persistent resource manager 1235. The communications manager 1215 may be an example of aspects of the communications manager 1410 described herein.

The CC dormancy manager 1220 may determine, for a UE, that one or more CCs of a set of CCs that are dormant.

The FDRA indication manager 1225 may configure a frequency resource allocation field of a DCI message to indicate a value that is invalid for frequency resource allocation on at least a first CC of the set of CCs and a subset of fields of the DCI message indicating information associated with the dormant one or more CCs.

The grant manager 1230 may transmit, to the UE, the DCI message associated with scheduling transmissions for the UE on the set of CCs.

The semi-persistent resource manager 1235 may transmit, to a UE, a configuration of semi-persistent resources for the UE using a set of CCs and determine an activation status for the semi-persistent resources.

The FDRA indication manager 1225 may configure, for at least a first CC of the set of CCs and the activation status, a frequency resource allocation field of a DCI message to indicate a value that is invalid for frequency resource allocation on the first CC.

The grant manager 1230 may transmit the DCI message to the UE conveying the invalid indication.

The transmitter 1240 may transmit signals generated by other components of the device 1205. In some examples, the transmitter 1240 may be collocated with a receiver 1210 in a transceiver module. For example, the transmitter 1240 may be an example of aspects of the transceiver 1420 described with reference to FIG. 14. The transmitter 1240 may utilize a single antenna or a set of antennas.

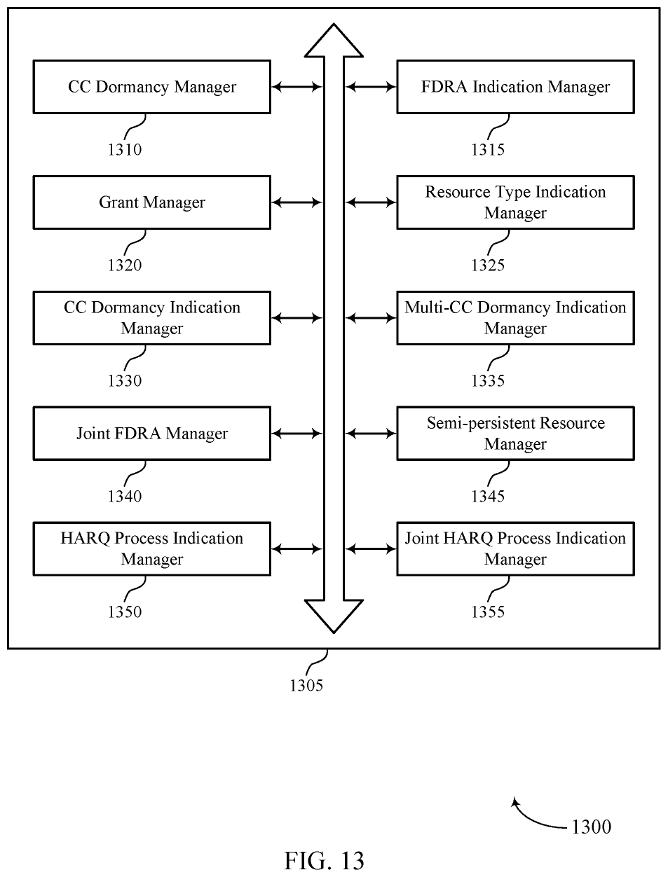

FIG. 13 shows a block diagram 1300 of a communications manager 1305 that supports secondary cell dormancy indication for scheduling multiple CCs in accordance with aspects of the present disclosure. The communications manager 1305 may be an example of aspects of a communications manager 1115, a communications manager 1215, or a communications manager 1410 described herein. The communications manager 1305 may include a CC dormancy manager 1310, a FDRA indication manager 1315, a grant manager 1320, a resource type indication manager 1325, a CC dormancy indication manager 1330, a multi-CC dormancy indication manager 1335, a joint FDRA manager 1340, a semi-persistent resource manager 1345, a HARQ process indication manager 1350, and a joint HARQ process indication manager 1355. Each of these modules may communicate, directly or indirectly, with one another (e.g., via one or more buses).

The CC dormancy manager 1310 may determine, for a UE, that one or more CCs of a set of CCs that are dormant.

The FDRA indication manager 1315 may configure a frequency resource allocation field of a DCI message to indicate a value that is invalid for frequency resource allocation on at least a first CC of the set of CCs and a subset of fields of the DCI message indicating information associated with the dormant one or more CCs. In some examples, the FDRA indication manager 1315 may configure, for at least a first CC of the set of CCs and the activation status, a frequency resource allocation field of a DCI message to indicate a value that is invalid for frequency resource allocation on the first CC.

The grant manager 1320 may transmit, to the UE, the DCI message associated with scheduling transmissions for the UE on the set of CCs. In some examples, the grant manager 1320 may transmit the DCI message to the UE conveying the invalid indication. In some cases, the subset of fields of the DCI message include one or more of a MCS scheme field, a NDI field, or a RV field. In some cases, the DCI message includes at least one of a separate frequency resource allocation field for each CC of the set of CCs or a joint frequency resource allocation field for the set of CCs.

The semi-persistent resource manager 1345 may transmit, to a UE, a configuration of semi-persistent resources for the UE using a plurality of CCs. In some examples, the semi-persistent resource manager 1345 may determine an activation status for the semi-persistent resources.

The resource type indication manager 1325 may set a bit in a resource allocation type field in the DCI message to a first value. In some examples, the resource type indication manager 1325 may set each bit in a bitmap indicated in the frequency resource allocation field associated with the first CC in the DCI message to the first value, where the value being invalid for frequency resource allocation on the first CC is based on each bit in the bitmap being set to the first value.

The CC dormancy indication manager 1330 may configure the subset of fields of the DCI message to indicate information identifying the dormant one or more CCs of the set of CCs. In some examples, the CC dormancy indication manager 1330 may map each bit of a bitmap indicated in the subset of fields to a CC of the set of CCs, where a value of each bit and the mapping indicate that the CC is active or dormant.

The multi-CC dormancy indication manager 1335 may configure the frequency resource allocation field of the DCI message associated with a second CC to indicate the value that is invalid for frequency resource allocation on the second CC. In some examples, the multi-CC dormancy indication manager 1335 may set a bit in a resource allocation type field associated with the second CC in the DCI message to a first value.

In some examples, the multi-CC dormancy indication manager 1335 may set each bit in a bitmap in the frequency resource allocation field associated with the second CC in the DCI message to the first value, where the value being invalid for frequency resource allocation on the second CC is based on each bit in the bitmap being set to the first value. In some examples, the multi-CC dormancy indication manager 1335 may configure the subset of fields associated with the first CC in the DCI message, a second subset of fields associated with the second CC in the DCI message, and a common subset of fields in the DCI message, to indicate information associated with the dormant one or more CCs of the set of CCs.

In some examples, the multi-CC dormancy indication manager 1335 may map each bit of a bitmap indicated in the subset of fields, the second subset of fields, and the common subset of fields, to a CC of the set of CCs, where a value of each bit and the mapping indicates that the CC is active or dormant.

The joint FDRA manager 1340 may configure the joint frequency resource allocation field to indicate that no resources are allocated to the first CC, where the value being invalid for frequency resource allocation on the first CC is based on no resources allocated to the first CC. In some examples, the joint FDRA manager 1340 may configure the subset of fields of the DCI message to indicate information identifying the dormant one or more CCs of the set of CCs.

In some examples, the joint FDRA manager 1340 may map each bit of a bitmap indicated in the subset of fields to a CC of the set of CCs. In some examples, the joint FDRA manager 1340 may set a value of each bit in the bitmap to indicate that the CC is active or dormant. In some examples, the joint FDRA manager 1340 may configure the frequency resource allocation field of the DCI message to indicate that no resources are allocated to the second CC, where the value being invalid for frequency resource allocation on the second CC is based on no resources allocated to the second CC.

In some examples, the joint FDRA manager 1340 may configure the subset of fields associated with the first CC in the DCI message, a second subset of fields associated with the second CC in the DCI message, and a common subset of fields in the DCI message, to indicate information identifying the dormant one or more CCs of the set of CCs. In some examples, the joint FDRA manager 1340 may map each bit of a bitmap indicated in the subset of fields, the second subset of fields, and the common subset of fields, to a CC of the set of CCs.

The HARQ process indication manager 1350 may configure a separate HARQ process number field in the DCI message for each CC in the set of CCs. In some examples, the HARQ process indication manager 1350 may configure each bit in the HARQ process number field and a redundancy version field of the DCI message to indicate the activation status for a semi-persistent resource associated with the first CC. In some examples, the HARQ process indication manager 1350 may set each bit in a redundancy version field to a first value based on the activation status for a set of semi-persistent resources associated with the first CC, where an identity of the set of semi-persistent resources is based on the HARQ process number field.

The joint HARQ process indication manager 1355 may configure a joint HARQ process number field in the DCI message for each CC in the set of CCs. In some examples, the joint HARQ process indication manager 1355 may configure the joint HARQ process number field and a redundancy version field in the DCI message based on the activation status for a semi-persistent resource associated with the first CC. In some examples, the joint HARQ process indication manager 1355 may set each bit in a redundancy version field to a first value based on the activation status for a set of semi-persistent resources associated with the first CC, where the semi-persistent resources associated with the first CC are identified based on the joint HARQ process number field.

FIG. 14 shows a diagram of a system 1400 including a device 1405 that supports secondary cell dormancy indication for scheduling multiple CCs in accordance with aspects of the present disclosure. The device 1405 may be an example of or include the components of device 1105, device 1205, or a base station 105 as described herein. The device 1405 may include components for bi-directional voice and data communications including components for transmitting and receiving communications, including a communications manager 1410, a network communications manager 1415, a transceiver 1420, an antenna 1425, memory 1430, a processor 1440, and an inter-station communications manager 1445. These components may be in electronic communication via one or more buses (e.g., bus 1450).

The communications manager 1410 may determine, for a UE, that one or more CCs of a set of CCs that are dormant, configure a frequency resource allocation field of a DCI message to indicate a value that is invalid for frequency resource allocation on at least a first CC of the set of CCs and a subset of fields of the DCI message indicating information associated with the dormant one or more CCs, and transmit, to the UE, the DCI message associated with scheduling transmissions for the UE on the set of CCs.

The communications manager 1410 may also transmit, to a UE, a configuration of semi-persistent resources for the UE using a set of CCs, determine an activation status for the semi-persistent resources, configure, for at least a first CC of the set of CCs and the activation status, a frequency resource allocation field of a DCI message to indicate a value that is invalid for frequency resource allocation on the first CC, and transmit the DCI message to the UE conveying the invalid indication.

The network communications manager 1415 may manage communications with the core network (e.g., via one or more wired backhaul links). For example, the network communications manager 1415 may manage the transfer of data communications for client devices, such as one or more UEs 115.

The transceiver 1420 may communicate bi-directionally, via one or more antennas, wired, or wireless links as described above. For example, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas.

In some cases, the wireless device may include a single antenna 1425. However, in some cases the device may have more than one antenna 1425, which may be capable of concurrently transmitting or receiving multiple wireless transmissions.

The memory 1430 may include RAM, ROM, or a combination thereof. The memory 1430 may store computer-readable code 1435 including instructions that, when executed by a processor (e.g., the processor 1440) cause the device to perform various functions described herein. In some cases, the memory 1430 may contain, among other things, a BIOS which may control basic hardware or software operation such as the interaction with peripheral components or devices.

The processor 1440 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some cases, a memory controller may be integrated into processor 1440. The processor 1440 may be configured to execute computer-readable instructions stored in a memory (e.g., the memory 1430) to cause the device 1405 to perform various functions (e.g., functions or tasks supporting secondary cell dormancy indication for scheduling multiple CCs).

The inter-station communications manager 1445 may manage communications with other base station 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communication network technology to provide communication between base stations 105.

The code 1435 may include instructions to implement aspects of the present disclosure, including instructions to support wireless communications. The code 1435 may be stored in a non-transitory computer-readable medium such as system memory or other type of memory. In some cases, the code 1435 may not be directly executable by the processor 1440 but may cause a computer (e.g., when compiled and executed) to perform functions described herein.

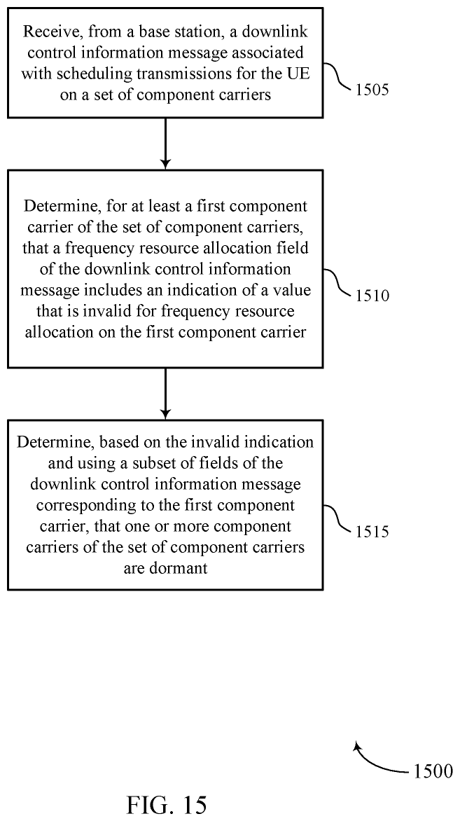

FIG. 15 shows a flowchart illustrating a method 1500 that supports secondary cell dormancy indication for scheduling multiple CCs in accordance with aspects of the present disclosure. The operations of method 1500 may be implemented by a UE 115 or its components as described herein. For example, the operations of method 1500 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1505, the UE may receive, from a base station, a DCI message associated with scheduling transmissions for the UE on a set of CCs. The operations of 1505 may be performed according to the methods described herein. In some examples, aspects of the operations of 1505 may be performed by a grant manager as described with reference to FIGS. 7 through 10.

At 1510, the UE may determine, for at least a first CC of the set of CCs, that a frequency resource allocation field of the DCI message includes an indication of a value that is invalid for frequency resource allocation on the first CC. The operations of 1510 may be performed according to the methods described herein. In some examples, aspects of the operations of 1510 may be performed by a FDRA indication manager as described with reference to FIGS. 7 through 10.

At 1515, the UE may determine, based on the invalid indication and using a subset of fields of the DCI message corresponding to the first CC, that one or more CCs of the set of CCs are dormant. The operations of 1515 may be performed according to the methods described herein. In some examples, aspects of the operations of 1515 may be performed by a CC dormancy manager as described with reference to FIGS. 7 through 10.

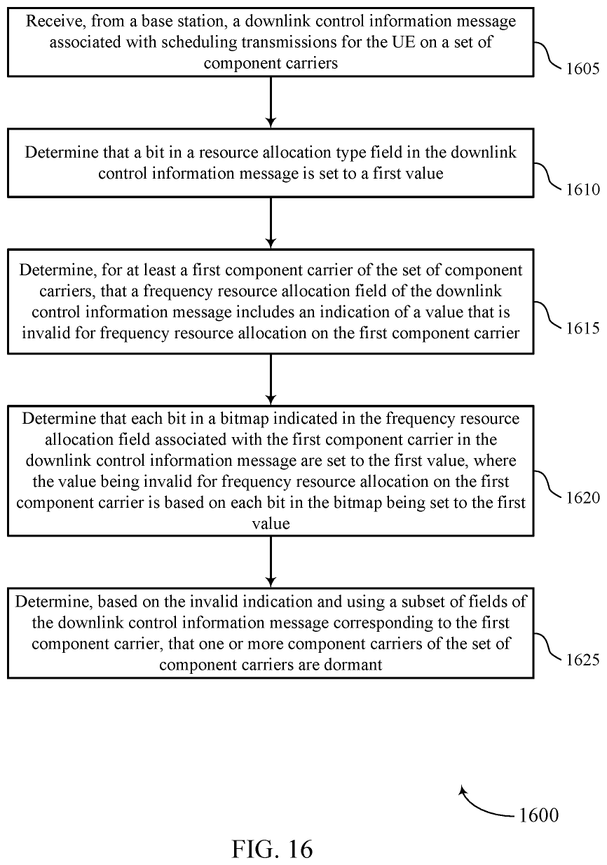

FIG. 16 shows a flowchart illustrating a method 1600 that supports secondary cell dormancy indication for scheduling multiple CCs in accordance with aspects of the present disclosure. The operations of method 1600 may be implemented by a UE 115 or its components as described herein. For example, the operations of method 1600 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1605, the UE may receive, from a base station, a DCI message associated with scheduling transmissions for the UE on a set of CCs. The operations of 1605 may be performed according to the methods described herein. In some examples, aspects of the operations of 1605 may be performed by a grant manager as described with reference to FIGS. 7 through 10.

At 1610, the UE may determine that a bit in a resource allocation type field in the DCI message is set to a first value. The operations of 1610 may be performed according to the methods described herein. In some examples, aspects of the operations of 1610 may be performed by a resource type indication manager as described with reference to FIGS. 7 through 10.

At 1615, the UE may determine, for at least a first CC of the set of CCs, that a frequency resource allocation field of the DCI message includes an indication of a value that is invalid for frequency resource allocation on the first CC. The operations of 1615 may be performed according to the methods described herein. In some examples, aspects of the operations of 1615 may be performed by a FDRA indication manager as described with reference to FIGS. 7 through 10.

At 1620, the UE may determine that each bit in a bitmap indicated in the frequency resource allocation field associated with the first CC in the DCI message are set to the first value, where the value being invalid for frequency resource allocation on the first CC is based on each bit in the bitmap being set to the first value. The operations of 1620 may be performed according to the methods described herein. In some examples, aspects of the operations of 1620 may be performed by a resource type indication manager as described with reference to FIGS. 7 through 10.

At 1625, the UE may determine, based on the invalid indication and using a subset of fields of the DCI message corresponding to the first CC, that one or more CCs of the set of CCs are dormant. The operations of 1625 may be performed according to the methods described herein. In some examples, aspects of the operations of 1625 may be performed by a CC dormancy manager as described with reference to FIGS. 7 through 10.

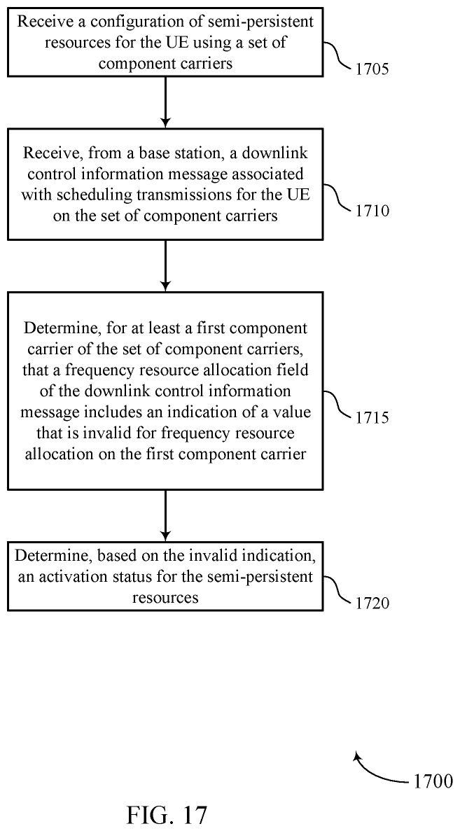

FIG. 17 shows a flowchart illustrating a method 1700 that supports secondary cell dormancy indication for scheduling multiple CCs in accordance with aspects of the present disclosure. The operations of method 1700 may be implemented by a UE 115 or its components as described herein. For example, the operations of method 1700 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1705, the UE may receive a configuration of semi-persistent resources for the UE using a set of CCs. The operations of 1705 may be performed according to the methods described herein. In some examples, aspects of the operations of 1705 may be performed by a semi-persistent resource manager as described with reference to FIGS. 7 through 10.

At 1710, the UE may receive, from a base station, a DCI message associated with scheduling transmissions for the UE on the set of CCs. The operations of 1710 may be performed according to the methods described herein. In some examples, aspects of the operations of 1710 may be performed by a grant manager as described with reference to FIGS. 7 through 10.

At 1715, the UE may determine, for at least a first CC of the set of CCs, that a frequency resource allocation field of the DCI message includes an indication of a value that is invalid for frequency resource allocation on the first CC. The operations of 1715 may be performed according to the methods described herein. In some examples, aspects of the operations of 1715 may be performed by a FDRA indication manager as described with reference to FIGS. 7 through 10.

At 1720, the UE may determine, based on the invalid indication, an activation status for the semi-persistent resources. The operations of 1720 may be performed according to the methods described herein. In some examples, aspects of the operations of 1720 may be performed by a semi-persistent resource manager as described with reference to FIGS. 7 through 10.

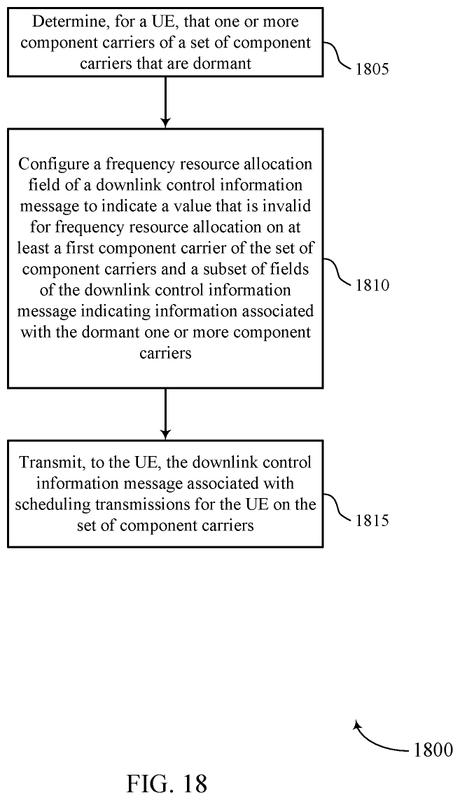

FIG. 18 shows a flowchart illustrating a method 1800 that supports secondary cell dormancy indication for scheduling multiple CCs in accordance with aspects of the present disclosure. The operations of method 1800 may be implemented by a base station 105 or its components as described herein. For example, the operations of method 1800 may be performed by a communications manager as described with reference to FIGS. 11 through 14. In some examples, a base station may execute a set of instructions to control the functional elements of the base station to perform the functions described below. Additionally or alternatively, a base station may perform aspects of the functions described below using special-purpose hardware.

At 1805, the base station may determine, for a UE, that one or more CCs of a set of CCs that are dormant. The operations of 1805 may be performed according to the methods described herein. In some examples, aspects of the operations of 1805 may be performed by a CC dormancy manager as described with reference to FIGS. 11 through 14.

At 1810, the base station may configure a frequency resource allocation field of a DCI message to indicate a value that is invalid for frequency resource allocation on at least a first CC of the set of CCs and a subset of fields of the DCI message indicating information associated with the dormant one or more CCs. The operations of 1810 may be performed according to the methods described herein. In some examples, aspects of the operations of 1810 may be performed by a FDRA indication manager as described with reference to FIGS. 11 through 14.

At 1815, the base station may transmit, to the UE, the DCI message associated with scheduling transmissions for the UE on the set of CCs. The operations of 1815 may be performed according to the methods described herein. In some examples, aspects of the operations of 1815 may be performed by a grant manager as described with reference to FIGS. 11 through 14.

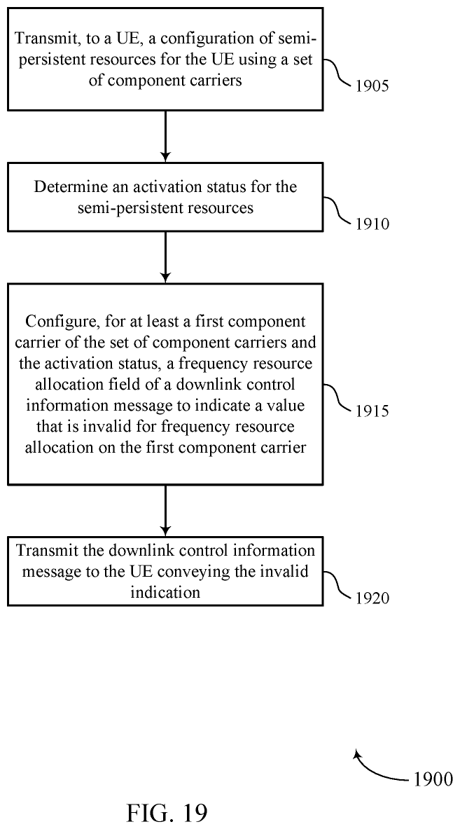

FIG. 19 shows a flowchart illustrating a method 1900 that supports secondary cell dormancy indication for scheduling multiple CCs in accordance with aspects of the present disclosure. The operations of method 1900 may be implemented by a base station 105 or its components as described herein. For example, the operations of method 1900 may be performed by a communications manager as described with reference to FIGS. 11 through 14. In some examples, a base station may execute a set of instructions to control the functional elements of the base station to perform the functions described below. Additionally or alternatively, a base station may perform aspects of the functions described below using special-purpose hardware.

At 1905, the base station may transmit, to a UE, a configuration of semi-persistent resources for the UE using a set of CCs. The operations of 1905 may be performed according to the methods described herein. In some examples, aspects of the operations of 1905 may be performed by a semi-persistent resource manager as described with reference to FIGS. 11 through 14.

At 1910, the base station may determine an activation status for the semi-persistent resources. The operations of 1910 may be performed according to the methods described herein. In some examples, aspects of the operations of 1910 may be performed by a semi-persistent resource manager as described with reference to FIGS. 11 through 14.

At 1915, the base station may configure, for at least a first CC of the set of CCs and the activation status, a frequency resource allocation field of a DCI message to indicate a value that is invalid for frequency resource allocation on the first CC. The operations of 1915 may be performed according to the methods described herein. In some examples, aspects of the operations of 1915 may be performed by a FDRA indication manager as described with reference to FIGS. 11 through 14.

At 1920, the base station may transmit the DCI message to the UE conveying the invalid indication. The operations of 1920 may be performed according to the methods described herein. In some examples, aspects of the operations of 1920 may be performed by a grant manager as described with reference to FIGS. 11 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a user equipment (UE), comprising:
receiving, from a base station, a downlink control information message associated with scheduling transmissions for the UE on a plurality of component carriers;
determining, for at least a first component carrier of the plurality of component carriers, that a frequency resource allocation field of the downlink control information message comprises an indication of a value that is invalid for frequency resource allocation on the first component carrier; and
determining, based at least in part on the invalid indication and using a subset of fields of the downlink control information message corresponding to the first component carrier, that one or more component carriers of the plurality of component carriers are dormant.

2. The method of claim 1, further comprising:
determining that a bit in a resource allocation type field in the downlink control information message is set to a first value; and
determining that each bit in a bitmap indicated in the frequency resource allocation field associated with the first component carrier in the downlink control information message are set to the first value, wherein the value being invalid for frequency resource allocation on the first component carrier is based at least in part on each bit in the bitmap being set to the first value.

3. (canceled)

4. The method of claim 2, further comprising:
mapping each bit of a bitmap indicated in the subset of fields to a component carrier of the plurality of component carriers; and
determining, based at least in part on a value of each bit and the mapping, that the component carrier is active or dormant.

5. The method of claim 1, further comprising:
determining, for at least a second component carrier of the plurality of component carriers, that the frequency resource allocation field of the downlink control information message associated with the second component carrier comprises an indication of a value that is invalid for frequency resource allocation on the second component carrier.

6. The method of claim 5, further comprising:
determining that a bit in a resource allocation type field associated with the second component carrier in the downlink control information message is set to a first value; and
determining that each bit in a bitmap in the frequency resource allocation field associated with the second component carrier in the downlink control information message are set to the first value, wherein the value being invalid for frequency resource allocation on the second component carrier is based at least in part on each bit in the bitmap being set to the first value.

7. The method of claim 5, further comprising:
identifying, based at least in part on the subset of fields associated with the first component carrier in the downlink control information message, a second subset of fields associated with the second component carrier in the downlink control information message, and a common subset of fields in the downlink control information message, the dormant one or more component carriers of the plurality of component carriers; mapping each bit of a bitmap indicated in the subset of fields, the second subset of fields, and the common subset of fields, to a component carrier of the plurality of component carriers; and
determining, based at least in part on a value of each bit and the mapping, that the component carrier is active or dormant.

8. Canceled

9. The method of claim 1, wherein the frequency resource allocation field comprises a joint frequency resource allocation field associated with the first component carrier and a second component carrier of the plurality of component carriers, comprising:
determining, based at least in part on the joint frequency resource allocation field, that no resources are allocated to the first component carrier, wherein the value being invalid for frequency resource allocation on the first component carrier is based at least in part on no resources allocated to the first component carrier.

10. Canceled

11. The method of claim 9, further comprising:
mapping each bit of a bitmap indicated in the subset of fields to a component carrier of the plurality of component carriers; and
determining, based at least in part on a value of each bit and the mapping, that the component carrier is active or dormant.

12. The method of claim 9, further comprising:
determining, for at least the second component carrier of the plurality of component carriers, that no resources are allocated to the second component carrier, wherein the value being invalid for frequency resource allocation on the second component carrier is based at least in part on no resources allocated to the second component carrier.

13. The method of claim 12, further comprising:
identifying, based at least in part on the subset of fields associated with the first component carrier in the downlink control information message, a second subset of fields associated with the second component carrier in the downlink control information message, and a common subset of fields in the downlink control information message, the dormant one or more component carriers of the plurality of component carriers.

14. The method of claim 13, wherein identifying the dormant one or more component carriers comprises:
mapping each bit of a bitmap indicated in the subset of fields, the second subset of fields, and the common subset of fields, to a component carrier of the plurality of component carriers; and
determining, based at least in part on a value of each bit and the mapping, that the component carrier is active or dormant.

15. Canceled

16. A method for wireless communication at a user equipment (UE), comprising:
receiving a configuration of semi-persistent resources for the UE using a plurality of component carriers;
receiving, from a base station, a downlink control information message associated with scheduling transmissions for the UE on the plurality of component carriers;
determining, for at least a first component carrier of the plurality of component carriers, that a frequency resource allocation field of the downlink control information message comprises an indication of a value that is invalid for frequency resource allocation on the first component carrier; and
determining, based at least in part on the invalid indication, an activation status for the semi-persistent resources.

17. The method of claim 16,
wherein the downlink control information message comprises a separate hybrid automatic repeat/request (HARQ) process number field for each component carrier in the plurality of component carriers, the method further comprising:
determining the activation status for a semi-persistent resource associated with the first component carrier based at least in part on each bit in the HARQ process number field and a redundancy version field being set to a first value.

18. (canceled)

19. The method of claim 16, wherein the downlink control information message comprises a separate hybrid automatic repeat/request (HARQ) process number field for each component carrier in the plurality of component carriers, the method further comprising:
determining the activation status for a plurality of semi-persistent resources associated with the first component carrier based at least in part on each bit in a redundancy version field being set to a first value; and
identifying the plurality of semi-persistent resources based at least in part on the HARQ process number field.

20. The method of claim 16,
wherein the downlink control information message comprises a joint hybrid automatic repeat/request (HARQ) process number field for each component carrier in the plurality of component carriers, the method further comprising:
determining the activation status for a semi-persistent resource associated with the first component carrier based at least in part on each bit in the HARQ process number field and a redundancy version field being set to a first value.

21. (canceled)

22. The method of claim 16, wherein the downlink control information message comprises a joint hybrid automatic repeat/request (HARQ) process number field for each component carrier in the plurality of component carriers, the method further comprising:
determining the activation status for a plurality of semi-persistent resources associated with the first component carrier based at least in part on each bit in a redundancy version field being set to a first value; and
identifying the plurality of semi-persistent resources associated with the first component carrier and a second component carrier based at least in part on the HARQ process number field.

23. (canceled)

24. A method for wireless communications at a base station, comprising:
determining, for a user equipment (UE), that one or more component carriers of a plurality of component carriers that are dormant;
configuring a frequency resource allocation field of a downlink control information message to indicate a value that is invalid for frequency resource allocation on at least a first component carrier of the plurality of component carriers and a subset of fields of the downlink control information message indicating information associated with the dormant one or more component carriers; and
transmitting, to the UE, the downlink control information message associated with scheduling transmissions for the UE on the plurality of component carriers.

25. The method of claim 24, further comprising:
setting a bit in a resource allocation type field in the downlink control information message to a first value; and
setting each bit in a bitmap indicated in the frequency resource allocation field associated with the first component carrier in the downlink control information message to the first value, wherein the value being invalid for frequency resource allocation on the first component carrier is based at least in part on each bit in the bitmap being set to the first value.

26. The method of claim 24, further comprising:
configuring the subset of fields of the downlink control information message to indicate information identifying the dormant one or more component carriers of the plurality of component carriers; and
mapping each bit of a bitmap indicated in the subset of fields to a component carrier of the plurality of component carriers, wherein a value of each bit and the mapping indicate that the component carrier is active or dormant.

27. (canceled)

28. The method of claim 24, further comprising:
configuring the frequency resource allocation field of the downlink control information message associated with a second component carrier to indicate the value that is invalid for frequency resource allocation on the second component carrier;
setting a bit in a resource allocation type field associated with the second component carrier in the downlink control information message to a first value; and
setting each bit in a bitmap in the frequency resource allocation field associated with the second component carrier in the downlink control information message to the first value, wherein the value being invalid for frequency resource allocation on the second component carrier is based at least in part on each bit in the bitmap being set to the first value.

29. (canceled)

30. The method of claim 28, further comprising:
configuring the subset of fields associated with the first component carrier in the downlink control information message, a second subset of fields associated with the second component carrier in the downlink control information message, and a common subset of fields in the downlink control information message, to indicate information associated with the dormant one or more component carriers of the plurality of component carriers; and
mapping each bit of a bitmap indicated in the subset of fields, the second subset of fields, and the common subset of fields, to a component carrier of the plurality of component carriers, wherein a value of each bit and the mapping indicates that the component carrier is active or dormant.

31. (canceled)

32. The method of claim 24, wherein the frequency resource allocation field comprises a joint frequency resource allocation field associated with the first component carrier and a second component carrier of the plurality of component carriers, the method further comprising:
configuring the joint frequency resource allocation field to indicate that no resources are allocated to the first component carrier, wherein the value being invalid for frequency resource allocation on the first component carrier is based at least in part on no resources allocated to the first component carrier.

33. The method of claim 32, further comprising:
configuring the subset of fields of the downlink control information message to indicate information identifying the dormant one or more component carriers of the plurality of component carriers;
mapping each bit of a bitmap indicated in the subset of fields to a component carrier of the plurality of component carriers; and
setting a value of each bit in the bitmap to indicate that the component carrier is active or dormant.

34. (canceled)

35. The method of claim 32, further comprising:
configuring the frequency resource allocation field of the downlink control information message to indicate that no resources are allocated to the second component carrier, wherein the value being invalid for frequency resource allocation on the second component carrier is based at least in part on no resources allocated to the second component carrier.

36. The method of claim 35, further comprising:
configuring the subset of fields associated with the first component carrier in the downlink control information message, a second subset of fields associated with the second component carrier in the downlink control information message, and a common subset of fields in the downlink control information message, to indicate information identifying the dormant one or more component carriers of the plurality of component carriers;
mapping each bit of a bitmap indicated in the subset of fields, the second subset of fields, and the common subset of fields, to a component carrier of the plurality of component carriers; and
setting a value of each bit in the bitmap to indicate that the component carrier is active or dormant.

37-38. (canceled)

39. A method for wireless communication at a base station, comprising:
transmitting, to a user equipment (UE), a configuration of semi-persistent resources for the UE using a plurality of component carriers;
determining an activation status for the semi-persistent resources;
configuring, for at least a first component carrier of the plurality of component carriers and the activation status, a frequency resource allocation field of a downlink control information message to indicate a value that is invalid for frequency resource allocation on the first component carrier; and
transmitting the downlink control information message to the UE conveying the invalid indication.

40. The method of claim 39, further comprising:
configuring a separate hybrid automatic repeat/request (HARQ) process number field in the downlink control information message for each component carrier in the plurality of component carriers; and
configuring each bit in the HARQ process number field and a redundancy version field of the downlink control information message to indicate the activation status for a semi-persistent resource associated with the first component carrier.

41. (canceled)

42. The method of claim 39, further comprising:
configuring a separate hybrid automatic repeat/request (HARQ) process number field in the downlink control information message for each component carrier in the plurality of component carriers; and
setting each bit in a redundancy version field to a first value based at least in part on the activation status for a plurality of semi-persistent resources associated with the first component carrier, wherein an identity of the plurality of semi-persistent resources is based at least in part on the HARQ process number field.

43. The method of claim 39, further comprising:
configuring a joint hybrid automatic repeat/request (HARQ) process number field in the downlink control information message for each component carrier in the plurality of component carriers; and
configuring the joint HARQ process number field and a redundancy version field in the downlink control information message based at least in part on the activation status for a semi-persistent resource associated with the first component carrier.

44. (canceled)

45. The method of claim 39, further comprising:
configuring a joint hybrid automatic repeat/request (HARQ) process number field in the downlink control information message for each component carrier in the plurality of component carriers; and
setting each bit in a redundancy version field to a first value based at least in part on the activation status for a plurality of semi-persistent resources associated with the first component carrier, wherein the semi-persistent resources associated with the first component carrier are identified based at least in part on the joint HARQ process number field.

46-184. (canceled)
